(19) United States
(12) Patent Application Publication
(10) Pub. No.: US 2017/0278603 A1
(43) Pub. Date: Sep. 28, 2017

(54) MAGNETIC COMPOSITES, METHOD OF MAKING THE SAME, AND ANTENNA DEVICE COMPRISING THE MAGNETIC COMPOSITES

(71) Applicant: SAMSUNG ELECTRONICS CO., LTD., Suwon-si (KR)

(72) Inventors: Kyoung-Seok MOON, Hwaseong-si (KR); Sang Eui LEE, Hwaseong-si (KR); Young Min KANG, Yongin-si (KR); Dong Hun KIM, Yongin-si (KR); Min Seok KIM, Seongnam-si (KR); Hiesang SOHN, Seoul (KR); In Taek HAN, Seoul (KR)

(21) Appl. No.: 15/338,649

(22) Filed: Oct. 31, 2016

(30) Foreign Application Priority Data
Mar. 28, 2016 (KR) 10-2016-0037182

(51) Int. Cl. H01F 1/055; H01F 41/02; H01Q 1/36

(52) U.S. Cl. CPC H01F 1/0551; H01Q 1/36; H01F 41/0253

(57) ABSTRACT

A magnetic composite includes a polymeric substrate and a magnetic material including a Z-type phase and represented by the following Chemical Formula:

Ba_{1.5-x}Sr_{1.5-x}Ca₂ₓM₂Fe₂₄O₄₁ Chemical Formula

wherein, in the Chemical Formula, M is at least one selected from Co, Ni, Cu, Mg, Mn, Ti, Al, Zn, and Zr, and 0≦x<0.3.

### CROSS REFERENCE TO RELATED APPLICATIONS

This application claims priority to and the benefit of Korean Patent Application No. 10-2016-0037182 filed in the Korean Intellectual Property Office on Mar. 28, 2016, and all the benefits accruing therefrom under 35 U.S.C. §119, the entire contents of which are incorporated herein by reference.

### BACKGROUND

1. Field

Magnetic composites, methods of making the same, and antennas including the magnetic composites are disclosed.

2. Description of the Related Art

Recently, as the mobile communication and information technology industries have been developed, an electronic device, such as a mobile phone and a laptop for producing, transmitting, and storing information is increasingly used, so that the down-sizing of an electronic device is an important issue. Thus, the down-sizing and a high frequency are also advantageous properties of an antenna used for an electronic device, based upon the trend in the down-sizing of an electronic device.

The frequency depends upon the type of electronic device and is relatively wide at a low frequency band of less than about 1 gigahertz (GHz) as well as at a high frequency band of greater than or equal to about 1 GHz. Research has been focused on obtaining the high frequency of antenna for adsorbing electromagnetic waves at the high frequency band.

Thus, it would be beneficial to develop an antenna having an excellent electromagnetic wave absorption performance for the wide frequency band until the low frequency band, as well as at the high frequency band.

### SUMMARY

An embodiment provides a magnetic composite having improved magnetic characteristics at low frequency and high frequency bands.

Another embodiment provides a method of making the magnetic composite.

Yet another embodiment provides an antenna including the magnetic composite.

According to an embodiment, a magnetic composite includes: a polymer substrate; and a magnetic material including a Z-type phase and represented by the following Chemical Formula,

Ba_{1.5-x}Sr_{1.5-x}Ca₂ₓM₂Fe₂₄O₄₁ Chemical Formula

Wherein, in the Chemical Formula, M is at least one selected from Co, Ni, Cu, Mg, Mn, Ti, Al, Zn, and Zr, and 0≦x<0.3.

The magnetic material may consist of a Z-type single phase.

The magnetic material may include a sheet-shaped particle, and a ratio of a length of a major axis of the sheet-shaped particle to a thickness of the sheet-shaped particle may be greater than or equal to about 4.

The length of the major axis of the sheet-shaped particle may be greater than 0 micrometer (μm) and less than or equal to about 50 μm.

The magnetic material may have a dielectric loss tangent of less than or equal to about 0.006 at a frequency band of about 400 megahertz (MHz) to about 800 MHz.

The magnetic material may have a magnetic loss tangent of less than or equal to about 0.05 at a frequency band of about 400 MHz to about 800 MHz.

The magnetic material may have a ratio of a permeability to a dielectric constant of greater than or equal to about 0.28, at a frequency band of about 400 MHz to about 800 MHz.

A magnetic saturation of the magnetic material may be less than or equal to about 64 electromagnetic units per gram (emu/g).

The magnetic material may be dispersed in the polymer substrate.

The magnetic material may be present in an amount of greater than or equal to about 50 weight percent (wt %), based on a total weight of the magnetic composite.

According to another embodiment, a method of making the magnetic composite includes: calcinating an iron-containing precursor at a temperature of about 1000° C. to about 1200° C. to obtain a calcinated precursor; mixing the calcinated precursor with a metal salt to obtain a precursor-metal salt mixture; sintering the precursor-metal salt mixture at a temperature of about 1100° C. to about 1300° C.; removing the metal salt from the sintered precursor-metal salt mixture to obtain the magnetic material; and contacting the magnetic material with a polymer resin to obtain the magnetic composite.

The metal salt may include at least one metal selected from Na, K, Ca, Mg, Sr, Ba, Al, Sc, Ti, V, Cr, Cu, Zn, Zr, Nb, Mo, and Ag.

The metal salt includes at least one salt selected from a chloride, a hydroxide, a nitrate, an acetate, a propionate, an acetylacetonate, a methoxide, an ethoxide, a phosphate, a C1 to 010 alkylphosphate, a perchloride, a sulfate, a C1 to 010 alkylsulfonate, and a C1 to 010 alkyl bromide.

A mass ratio of the precursor to the metal salt in the precursor-metal salt mixture may be about 2:1 to about 1:2.

The method may further include uniaxial pressing the precursor-metal salt mixture before sintering the precursor-metal salt mixture.

The method may include mixing the magnetic material and the polymer resin to obtain a magnetic material-polymer composite resin.

The method may further include curing the magnetic material-polymer composite resin.

According to another embodiment, an antenna includes the magnetic composite.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a scanning electron microscope (SEM) image of a magnetic composite according to an embodiment;

FIG. 2 is a graph of relative intensity (arbitrary units, a.u.) versus diffraction angle (degrees 2-theta) showing the results of X-ray diffraction (XRD) analyses of Examples 1 to 9 and Intermediates 1 to 3;

FIGS. 3A to 3L are scanning electron microscope (SEM) images of Examples 1 to 9 and Intermediates 1 to 3 prepared under different calcination and sintering temperature conditions;

FIG. 4 is a graph of relative intensity (a.u.) versus diffraction angle (degrees 2-theta) showing the results of XRD analyses of Examples 10 to 18 and Intermediates 4 to 6;

FIGS. 5A to 5L are SEM images of Examples 10 to 18 and Intermediates 4 to 6 prepared under different calcination and sintering temperature conditions;

FIG. 6 is a graph of coercive force (H)(oersted, Oe) versus sintering temperature (degrees Celsius, ° C.) for Examples 1 to 9;

FIG. 7 is a graph of magnetic saturation (magnetization, Mₛ)(electromagnetic units per gram, emu/g) versus temperatures (° C.) for Examples 1 to 9;

FIG. 8 is a graph showing the intrinsic impedance of Examples 1 to 9;

FIG. 9 is a graph showing the dielectric loss tangent of Examples 1 to 9;

FIG. 10 is a graph showing the magnetic loss tangent of Examples 1 to 9; and

FIG. 11 is a graph of magnetic loss tangent versus frequency (megahertz, MHz) for Example 9, Example 18, and the Comparative Example.

### DETAILED DESCRIPTION

Exemplary embodiments will hereinafter be described in detail, and may be easily performed by those who have knowledge in the related art. However, this disclosure may be embodied in many different forms and is not to be construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Further, the singular includes the plural unless mentioned otherwise.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkyl” as used herein means a straight or branched chain saturated aliphatic hydrocarbon having the specified number of carbon atoms, specifically 1 to 12 carbon atoms, more specifically 1 to 10 carbon atoms, even more specifically 1 to 6 carbon atoms. Alkyl groups include, for example, groups having from 1 to 50 carbon atoms (C1 to C50 alkyl).

In order to achieve both a down-sizing and a high frequency in an antenna, it is possible to reduce the wavelength at the operation frequency of the electronic device using a magnetic material having a high dielectric constant. However, due to the high dielectric constant of the magnetic material, the energy delivered to the antenna is blocked by the magnetic material, causing a reduction in the impedance band width or the efficiency at a low frequency band.

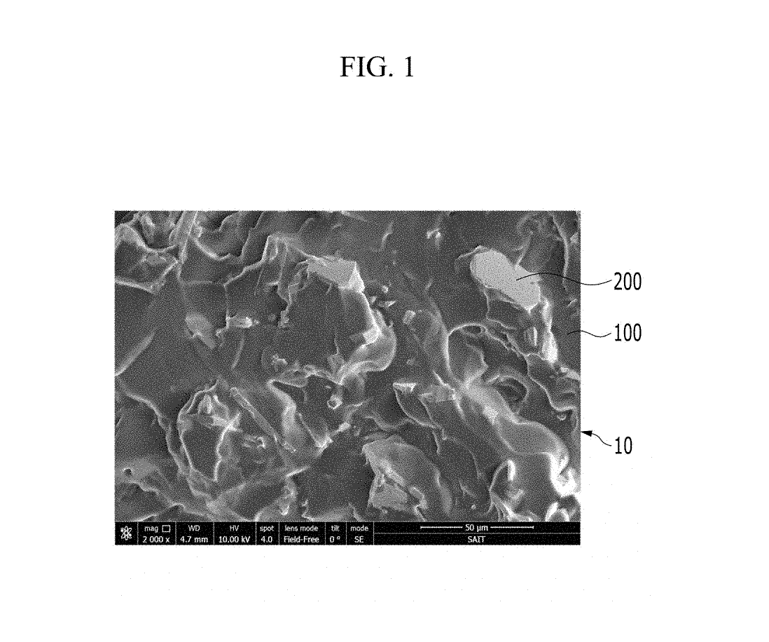

Hereinafter, a structure of a magnetic composite according to an embodiment is described referring to FIG. 1.

FIG. 1 shows a SEM image of a magnetic composite according to an embodiment.

Referring to FIG. 1, a magnetic composite 10 according to an embodiment includes a polymer substrate 100 and a magnetic powder 200 combined with the polymer substrate 100. The magnetic powder 200 is a magnetic material in a powder form.

The polymer substrate 100 may be formed by curing a polymer resin in a desired shape. Since the polymer substrate 100 may be relatively easily coated and cured, the shape thereof may be variously designed using the polymer resin, unlike an amorphous sheet including an amorphous alloy, a carbon nanosheet, a ferrite sheet, or the like.

The shape of the polymer substrate 100 is not particularly limited and may any various shape other than a sheet shape. For example, the polymer substrate 100 may have a shape selected from at least one of a belt, circle, oval, sphere, and amorphous shape.

As the polymer substrate 100 has the various shapes as described above, the magnetic composite 10 including the polymer substrate, may also have the various shapes corresponding to the polymer substrate 100.

Also, when the polymer substrate 100 has excellent wettability relative to the magnetic powder 200, the polymer substrate 100 may cover the entire surface of the magnetic powder 200 as shown in FIG. 1, and also the shape of the magnetic powder 200 may appear as it is on the surface of the polymer substrate 100.

However, an embodiment is not necessarily limited thereto, and only a portion of a surface of the magnetic powder 200 may be covered, as shown in FIG. 1.

In an embodiment, the type of polymer used as the polymer substrate 100 is not particularly limited, and the polymer may be obtained by polymerizing the various commercially available monomers.

Also, by using the polymer substrate 100 which can be less costly than an amorphous sheet, a carbon nanosheet, and a ferrite sheet, and which has a relatively low permeability, the manufacturing cost of the magnetic composite 10 may be reduced. In addition, the slimming and down-sizing of an antenna may be accomplished when the magnetic composite 10 having the various shapes is applied to the various types of antennas used for a wireless communication device.

In an embodiment, the magnetic powder 200 may be a hexagonal ferrite (hereinafter, hexaferrite) material including a Z-type phase. The magnetic powder 200 may be present in an amount of greater than or equal to about 30 weight percent (wt %), for example greater than or equal to about 40 wt %, greater than or equal to about 50 wt %, greater than or equal to about 80 wt %, or about 80 wt % to about 99 wt %, based on the total weight of the magnetic composite 10. As the amount of the magnetic powder 200 in the magnetic composite 10 increases, the magnetic characteristics of the magnetic composite 10 are improved.

The magnetic powder 200 may be represented by the following Chemical Formula.

Ba_{1.5-x}Sr_{1.5-x}Ca₂ₓM₂Fe₂₄O₄₁ Chemical Formula

In the Chemical Formula, M is at least one selected from Co, Ni, Cu, Mg, Mn, Ti, Al, Zn, and Zr, and 0≦x<0.3.

As used herein, “Z-type” means that the material is isostructural with 3BaO.2MeO.12Fe₂O₃.

In an embodiment, the magnetic powder 200 may further include at least one phase of an M-type phase, a Y-type phase, a W-type phase, and a CoFe₂O₄ phase (a spinel structure), in addition to the Z-type phase. That is, the magnetic powder 200 may consist of, or consist essentially of, a mixed phase of the Z-type phase and a different phase, for example, two or more different phases.

However, the embodiment is not limited thereto, and the magnetic powder 200 may consist of, or consist essentially of, a Z-type single phase. While not wanting to be bound by theory, this is understood to be because the particle shape and the particle growth rate of the phase of the magnetic powder 200 are changed depending upon the temperature used during the manufacturing process of the magnetic powder 200.

The phase of the magnetic powder 200, the phase change according to the manufacturing process, and the resulting property changes caused thereby, will be described later.

Also, the magnetic powder 200 may include a sheet-shaped (e.g. flake) particle, which corresponds to a unit body, for either a magnetic powder 200 including a Z-type single phase or a mixed phase of two or more phases. When the magnetic powder 200 has a Z-type phase, the flake particles are separated from each other, but when the magnetic powder 200 has a mixed phase of two or more phases, the two or more sheet-shaped particles may be agglomerated to form an agglomeration.

The sheet-shaped (flake) particles may have a planar shape in the form of a hexagon or hexagon-like, and a ratio of a length of the major axis of the sheet-shaped particle relative to a thickness of the sheet-shaped particle may be greater than or equal to about 4.

The term “major axis” of the sheet-shaped particle refers to a distance between the farthest two vertexes in the case where the planar shape of sheet-shaped particle is a hexagon. In the case where the planar shape of the sheet-shaped particles is hexagon-like, the major axis refers to a distance between predetermined, two farthest points.

In an embodiment, when a ratio of a major axis of the sheet-shaped particle relative to a thickness of the sheet-shaped particle is greater than or equal to about 4, the magnetic powder 200 has improved magnetic anisotropy.

The length of the major axis of the sheet-shaped particle may be, for example, less than or equal to about 100 micrometers (μm), less than or equal to about 80 μm, and less than or equal to about 60 μm. For example, the length of the major axis may be greater than 0 μm and less than or equal to about 50 μm, or greater than 0 μm and less than or equal to about 30 μm. When the length of the major axis of the sheet-shaped particle is within the above ranges, the magnetic powder 200 implements improved magnetic characteristics.

On the other hand, the magnetic powder 200 may be dispersed in the polymer substrate 100 as shown in FIG. 1. That is, the magnetic powder 200 may be dispersed on the surface and/or inside of the polymer substrate 100. The surface of the magnetic powder 200 may be substantially covered by the polymer substrate 100, and at least one portion thereof may be exposed without being covered by the polymer substrate 100.

A magnetic saturation of the magnetic powder 200 may be, for example, less than about 80 electromagnetic units per gram (emu/g), for example less than or equal to about 70 emu/g, for example less than or equal to about 65 emu/g, for example less than or equal to about 64 emu/g. For example, the magnetic saturation may be about 40 emu/g to about 64 emu/g, or about 50 emu/g to about 65 emu/g.

A coercive force (H) of the magnetic powder 200 may be, for example, less than or equal to about 500 Oersteds (Oe). For example, the coercive force of the magnetic powder 200 may be greater than 0 Oe and less than or equal to about 490 Oe, greater than 0 Oe and less than or equal to about 250 Oe, or greater than 0 Oe and less than or equal to about 100 Oe.

When the magnetic saturation and the coercive force of the sheet-shaped particle are within the above-described ranges, the magnetic powder 200 may implement excellent soft magnetism characteristics.

On the other hand, the magnetic powder 200 may minimize a dielectric loss and a magnetic loss at a low frequency band of less than about 1 GHz, for example, at a frequency band of about 400 megaHertz (MHz) to about 800 MHz.

For example, the magnetic powder 200 may have a dielectric loss tangent (tan δ₁) of less than or equal to about 0.006, for example, less than or equal to about 0.0059, for example less than or equal to about 0.0058, at a frequency band of about 400 MHz to about 800 MHz.

The magnetic powder 200 may have a magnetic loss tangent (tan δ₂) less than or equal to about 0.05, for example, less than or equal to about 0.03, less than or equal to about 0.02, or less than or equal to about 0.018, at a frequency band of about 400 MHz to about 800 MHz.

The magnetic powder 200 may have a ratio of a permeability to a dielectric constant of greater than or equal to about 0.2, for example, greater than or equal to about 0.23, greater than or equal to about 0.25, or greater than or equal to about 0.28, at a frequency band of about 400 MHz to about 800 MHz. When a ratio of a permeability to a dielectric constant at the low frequency band satisfies the above-described range, the intrinsic impedance of the magnetic powder 200 is increased, so the band width of the magnetic composite 10 including the magnetic powder 200 may be enhanced.

However, according to an embodiment, since the magnetic powder 200 is a ferritic powder used for a high frequency antenna, the dielectric loss and the magnetic loss at a low frequency band of less than 1 gigaHertz (GHz) may be minimized, and, furthermore, the magnetic characteristics are excellent also at a high frequency band of greater than or equal to about 1 GHz. In other words, an embodiment may provide a magnetic composite 10 which may be used for an antenna having a wide band width extending from a low frequency band to a high frequency band.

In the magnetic composite 10 according to an embodiment, the magnetic powder 200 may be disposed on a single surface (e.g. an upper surface) of a polymer substrate 100 as shown in FIG. 1. However, an embodiment is not necessarily limited thereto, and the magnetic powder 200 may be disposed on both surfaces (e.g. an upper surface and a lower surface) of the polymer substrate 100, and/or the magnetic powder 200 may be disposed in the polymer substrate 100.

As described in above, an embodiment may provide a magnetic composite 10 in which the dielectric loss and the magnetic loss are minimized at a low frequency band of less than about 1 GHz, by including a magnetic powder 200 having excellent magnetic characteristics (e.g. soft magnetism characteristics).

Hereinafter, an antenna including the magnetic composite 10 is described.

The antenna including the magnetic composite 10 has a form in which the magnetic powder 200 is present on the surface of a polymer substrate 100, within the polymer substrate, or combined combination thereof, so as to facilitate the slimming and down-sizing of the antenna.

The antenna according to another embodiment shows excellent magnetic characteristics across a wide frequency band extending from a low frequency band to a high frequency band, so as to be widely applicable for electric devices which transmit/receive electromagnetic waves at both the low frequency band and the high frequency band or electric devices for the stable adsorption of electromagnetic waves at a low frequency band.

For example, the antenna according to another embodiment may be usable for a transmitter/receiver of medical implant communication service (MICS) device, a transmitter/receiver of radio frequency identification (RFID) device widely used in security and distribution fields, and a transmitter/receiver of channel for a digital multimedia broadcasting (DMB) device, and the like.

On the other hand, hereinafter, a method of making the magnetic composite is described.

A method of making the magnetic composite includes calcinating an iron (Fe)-containing precursor at a temperature of about 1000° C. to about 1200° C. (calcinating process) to obtain a calcinated precursor, mixing the calcinated precursor with a metal salt to obtain a precursor-metal salt mixture (obtaining process of a precursor-metal salt mixture), sintering the precursor-metal salt mixture at a temperature of about 1100° C. to about 1300° C. (sintering process), removing the metal salt from the sintered precursor-metal salt mixture to obtain the magnetic powder (obtaining process of a magnetic powder), and contacting the magnetic powder with a polymer resin to obtain the magnetic composite.

First, an iron (Fe)-containing precursor is prepared. The precursor may be a powder-type precursor including at least iron (Fe), and further including barium (Ba), strontium (Sr), and additionally calcium (Ca). In addition to the above metals, the iron (Fe)-containing precursor may further include at least one selected from cobalt (Co), nickel (Ni), copper (Cu), magnesium (Mg), manganese (Mn), titanium (Ti), aluminum (Al), zinc (Zn), and zirconium (Zr). Stoichiometric ratios of elements in the precursor are the same as in the Chemical Formula.

Then as a pre-step for the calcination, the iron (Fe)-containing precursor in which the elements are combined, is added into a dispersive medium and then mixed, ground, and dried to provide an iron (Fe)-containing precursor in which the elements are ground.

Then the iron (Fe)-containing precursor is calcinated at a temperature of about 1000° C. to about 1200° C. in the calcinating process, to obtain a calcinated precursor. In an embodiment, the iron (Fe)-containing precursor may be calcinated for about 1 hour to about 8 hours, for example, about 2 hours to about 8 hours, for example, about 4 hours to about 8 hours.

In the calcinating process, elements in the iron (Fe)-containing precursor are chemically bonded to form a particle, and the particle is slowly grown during the process of performing the calcination. The particles may have different phases from each other depending upon the particular calcinating temperature which is used. For example, when the calcinating temperature is adjusted to a temperature of about 1000° C., a 2-phase or 3 or more phase intermediate particle including an M-type phase, may be formed in the calcinated precursor after completing the calcinating process. In addition, for example, when the calcinating temperature is adjusted to a temperature of about 1200° C., a 2-phase, or 3 or more phase intermediate particle further including a Z-type phase, may be formed in the calcinated precursor after completing the calcinating process.

Then the process of obtaining a precursor-metal salt mixture may be performed by adding a metal salt to the calcinated precursor after completing the calcination step and mixing the same. The mixture of the metal salt and the calcinated precursor is then added into a dispersive medium, mixed, ground, and then dried to provide a precursor-metal salt mixture in which the precursor and the metal salt are uniformly mixed.

The method of making a magnetic composite according to an embodiment uses the so-called molten salt method which includes mixing a metal salt with the primarily calcinated precursor and sintering the same together. When the metal salt is mixed with the calcinated precursor and sintered all together, the metal salt may induce the particle in the calcinated precursor to grow in a predetermined direction during the subsequent sintering process. That is, it is easy to control the shaping of the particle into a sheet shape during the calcinating process, and thereby, it may provide a sheet-shaped particle having a ratio of length of a major axis of the sheet-shaped particle to a thickness of the sheet-shaped particle of greater than or equal to about 4.

In an embodiment, the metal salt may include at least one metal selected from sodium (Na), potassium (K), calcium (Ca), magnesium (Mg), strontium (Sr), barium (Ba), aluminum (Al), scandium (Sc), titanium (Ti), vanadium (V), chromium (Cr), copper (Cu), zinc (Zn), zirconium (Zr), niobium (Nb), molybdenum (Mo), and silver (Ag).

In an embodiment, the metal salt may include at least one salt selected from a chloride, a hydroxide, a nitrate, an acetate, a propionate, an acetylacetonate, a methoxide, an ethoxide, a phosphate, a C1 to C10 alkylphosphate, a perchloride, a sulfate, a C1 to C10 alkylsulfonate, and a C1 to C10 alkyl bromide.

In an embodiment, a mass ratio of the precursor to the metal salt may be, for example, about 2:1 to about 1:2, for example, about 1:1 in the precursor-metal salt mixture. When the mass ratio of the precursor to the metal salt in the precursor-metal salt mixture is within the above range, particles in the precursor may be easily grown in a predetermined direction during the sintering process.

Meanwhile, before sintering the precursor-metal salt mixture, the precursor-metal salt mixture is uniaxially pressed and shaped to provide a pellet-shaped specimen.

Subsequently, in the sintering process, the pellet-shaped specimen is sintered at a temperature of about 1100° C. to about 1300° C. In an embodiment, the specimen may be sintered for about 1 hour to about 12 hours, for example, about 4 hours to about 10 hours, for example, about 5 hours to about 8 hours.

The phase of the intermediate particles formed during the calcinating process is changed through the sintering process. In addition, individual intermediate particles have different phases from each other depending upon the particular sintering temperature. The phase change which occurs in the calcinating process and the phase change which occurs in the sintering process are dependent upon both the change in particle state according to a temperature and the stoichiometric ratio of metals in the iron-containing precursor, which is a starting material. The phase change of the particle which occurs by the calcinating and sintering will be described later.

Thereafter, according to an embodiment, in the process of obtaining the magnetic powder, the sintered pellet is finely ground using a grinding means such as an agate mortar, and then a metal salt is removed from the ground sintered body, for example by washing the same and the like, and the ground sintered body is dried to provide a magnetic powder.

The obtained magnetic powder includes a sheet-shaped particle, which is an unit body, having a ratio of a length of a major axis to a thickness of greater than or equal to about 4. The sheet-shaped particle may be scattered separate from each other as a powder; agglomerated in groups of two or more to form a spinel-like structure; or agglomerated in a large amount to form an agglomerate, depending upon the calcinating and sintering conditions,

Meanwhile, the method of making a magnetic composite according to an embodiment may include mixing the obtained magnetic powder with a polymer resin to provide a magnetic powder-polymer composite resin.

The method of obtaining a magnetic powder-polymer composite resin is performed by mixing the obtained magnetic powder with the prepared polymer resin and agitating the same. Thereby, the magnetic powder may be dispersed in a polymer substrate. In other words, the dispersed magnetic powder may be dispersed on the surface of polymer substrate and/or inside the polymer substrate.

In addition, the method of making a magnetic composite according to an embodiment may further include a subsequent process of curing the magnetic powder-polymer composite resin. In the curing step, the specific curing method and the conditions used may be different depending upon the type of polymer resin, the amount of the magnetic powder-polymer composite resin, and the desired use of the final magnetic composite, or the like. For example, when the polymer substrate is a photocurable resin, the polymer substrate may be cured by radiating a light source such as ultraviolet (UV) light, and when the polymer is a thermosetting resin, the polymer substrate may be cured by a heat source such as a lamp.

The magnetic powder-polymer composite resin becomes a magnetic composite by implementing the curing step. In the magnetic composite, the magnetic powder is dispersed in the polymer substrate as shown in FIG. 1. When the magnetic powder is dispersed in the polymer resin to provide a magnetic composite, the surface of the dispersed magnetic powder may be substantially covered by the polymer substrate, and at least one portion of the magnetic powder may be exposed without being covered by the polymer substrate.

However, an embodiment is not necessarily limited thereto, and, for example, the obtained magnetic powder may be coated on one or more surface of the polymer resin to provide a magnetic powder layer, and a polymer resin may be further coated on the formed magnetic powder layer, and the like, so as to provide a magnetic composite including two or more magnetic powder layers such as a polymer resin-magnetic powder layer/polymer resin-magnetic powder layer.

The method of making the magnetic composite according to an embodiment may induce and accelerate the growth of the sheet-shaped particle having excellent magnetic anisotropy by mixing a molten salt with a calcinated precursor and sintering all together after the calcinating process. The method may also provide a magnetic composite in which the dielectric loss and the magnetic loss are minimized, as described above, by controlling each of the calcinating and sintering temperatures.

In addition, since the polymer resin capable of being processed in the various shapes is used as a substrate, it may be possible to both slim and down-size an antenna including the magnetic composite.

Hereinafter, the embodiments are illustrated in more detail with reference to examples. However, they are example embodiments, and the present disclosure is not limited thereto.

### EXAMPLES

### Manufacture of Intermediate 1

BaCO₃, SrCO₃, CO₃O₄, Fe₂O₃, which are starting materials, are weighted to provide a mole ratio of Ba:Sr:Co:Fe=1.5:1.5:2:24 and mixed, so as to provide an iron-containing precursor. Subsequently, the iron-containing precursor and a dispersive medium of water or ethanol are mixed, ground using a ball mill for 24 hours, and dried.

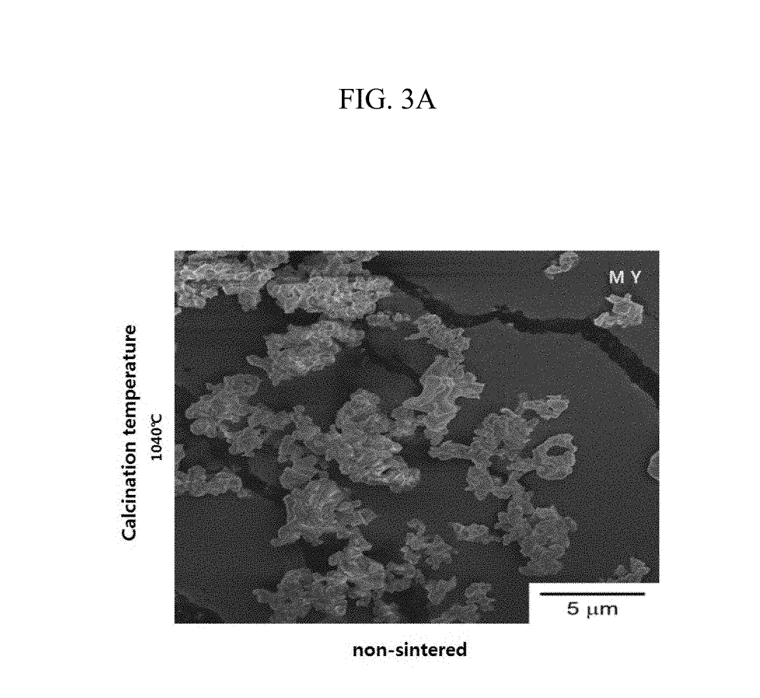

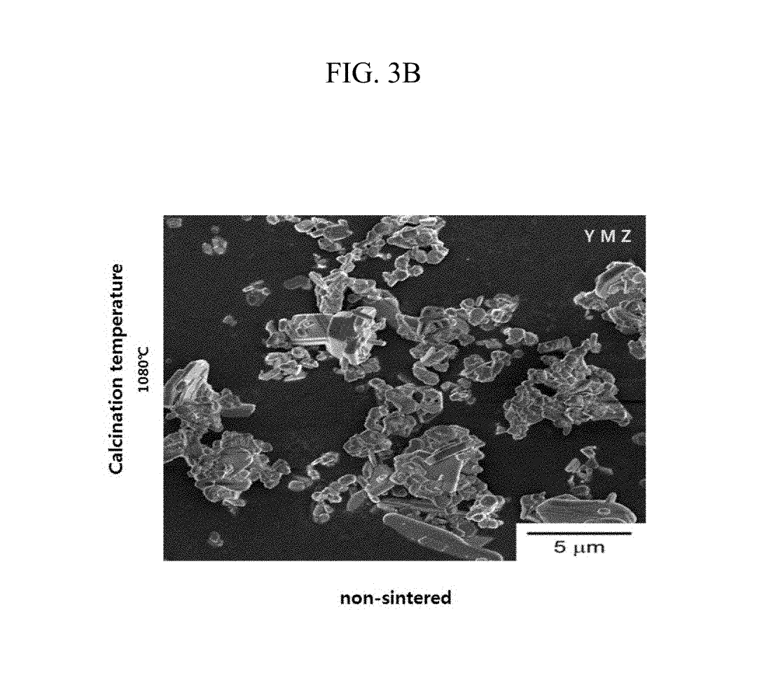

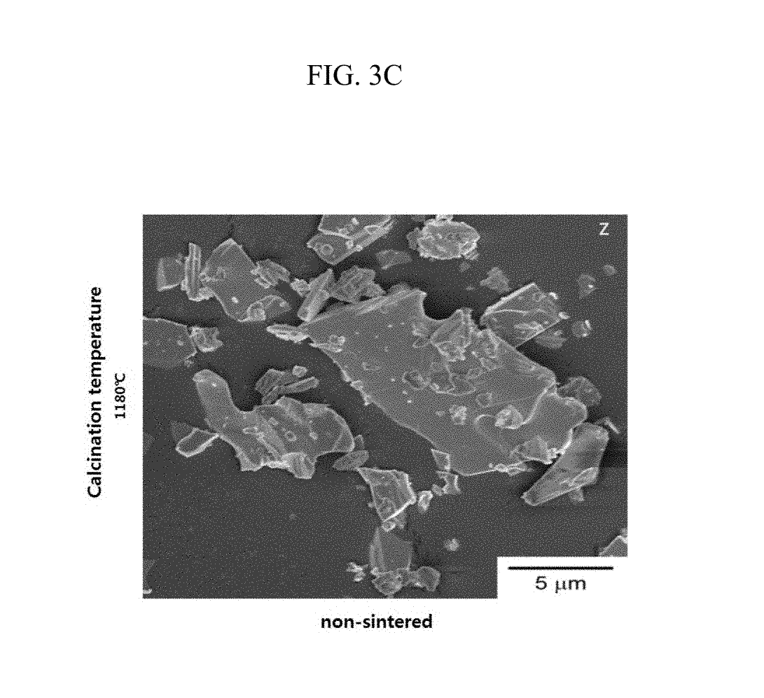

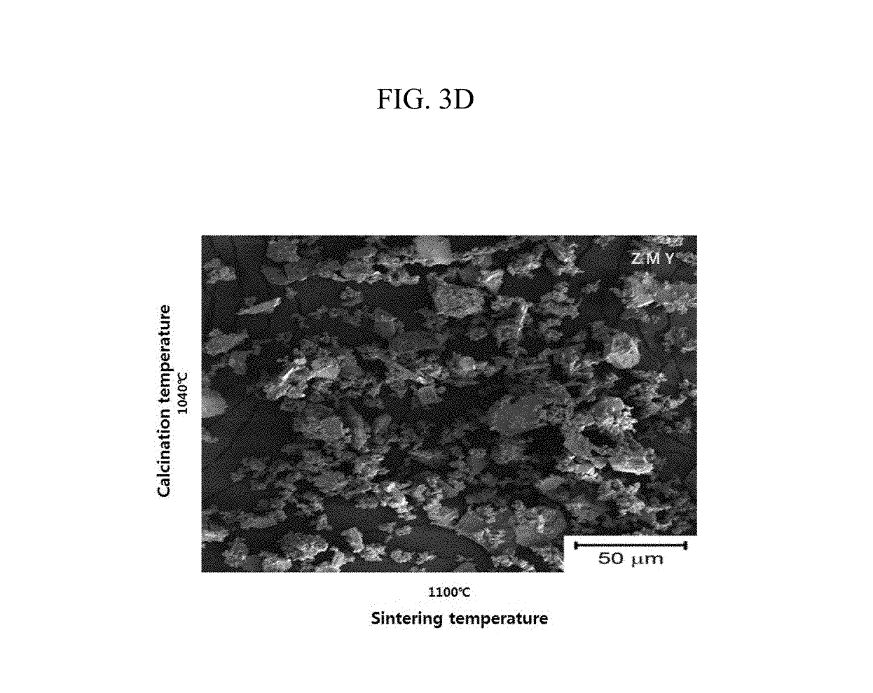

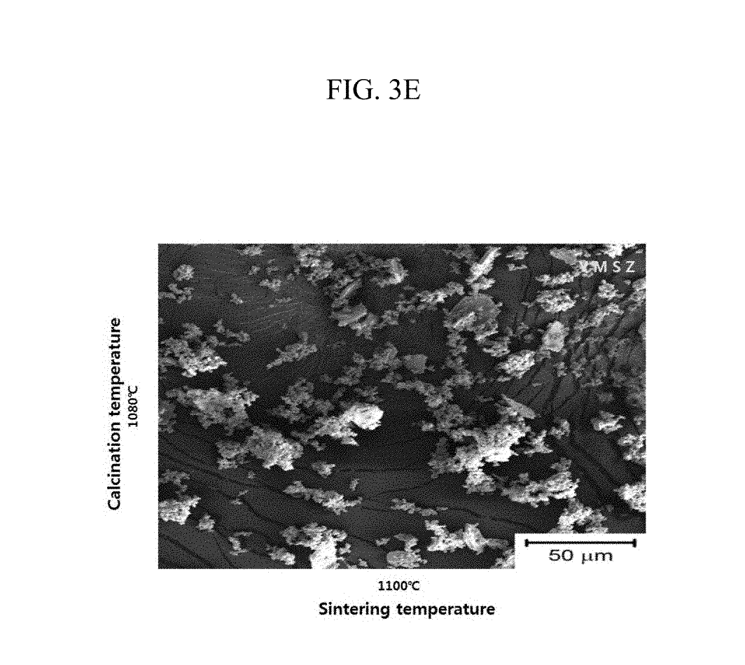

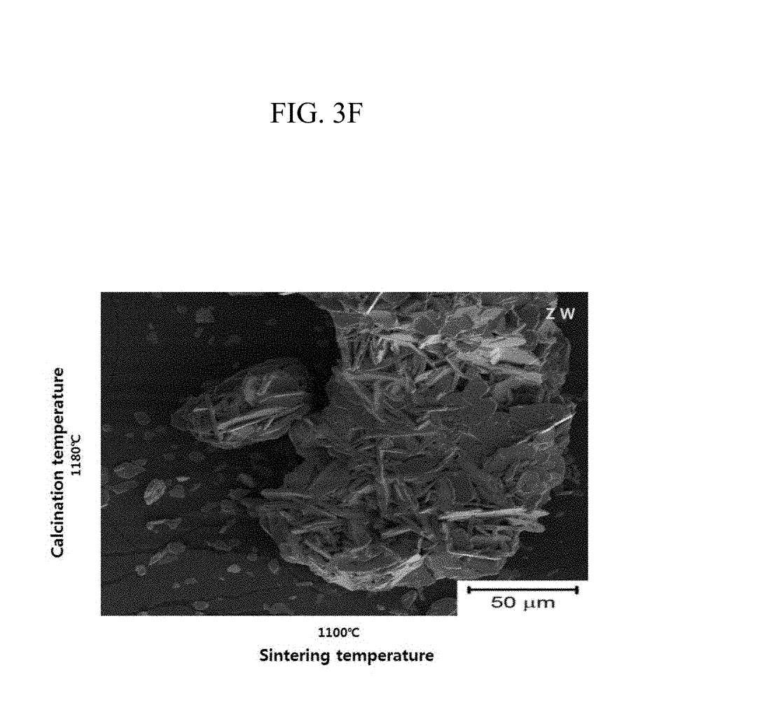

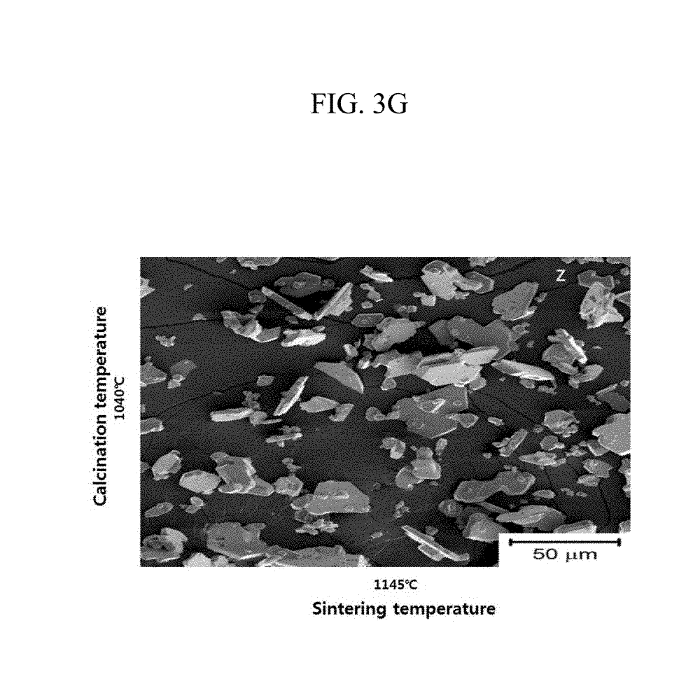

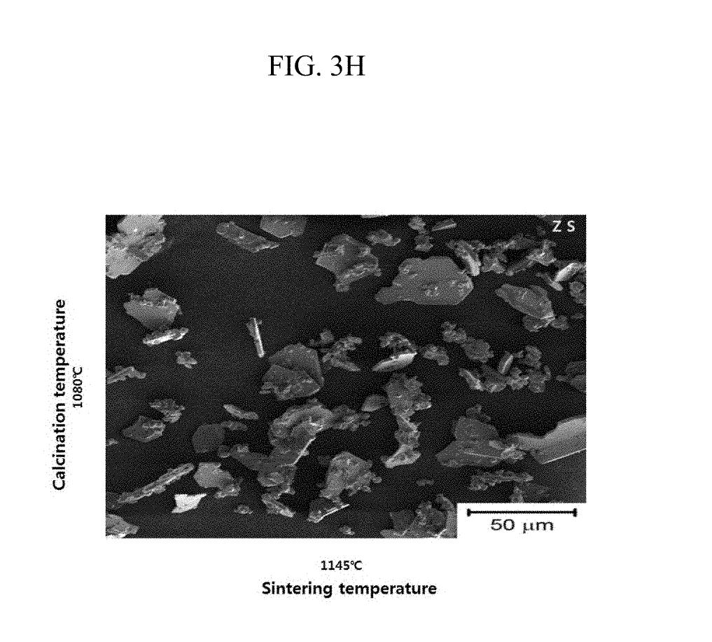

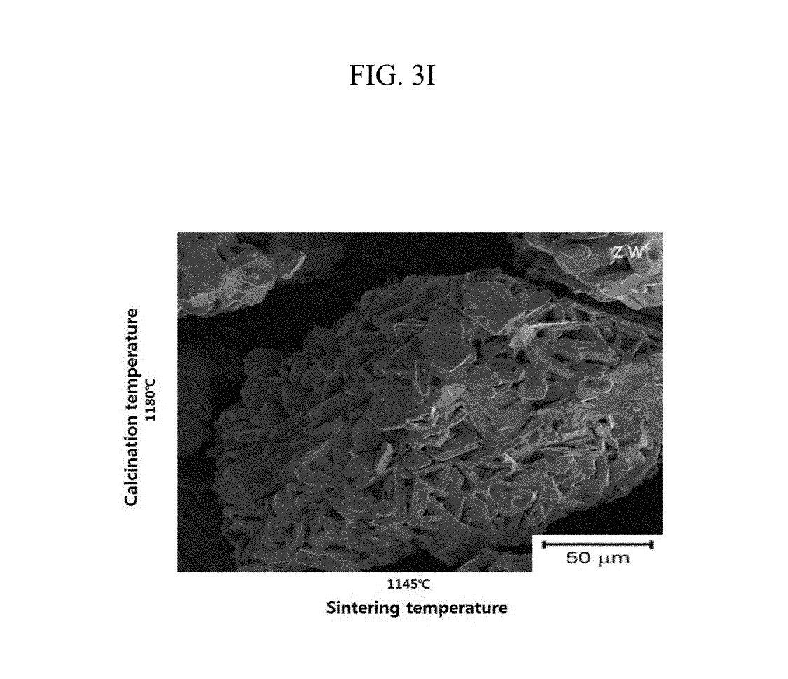

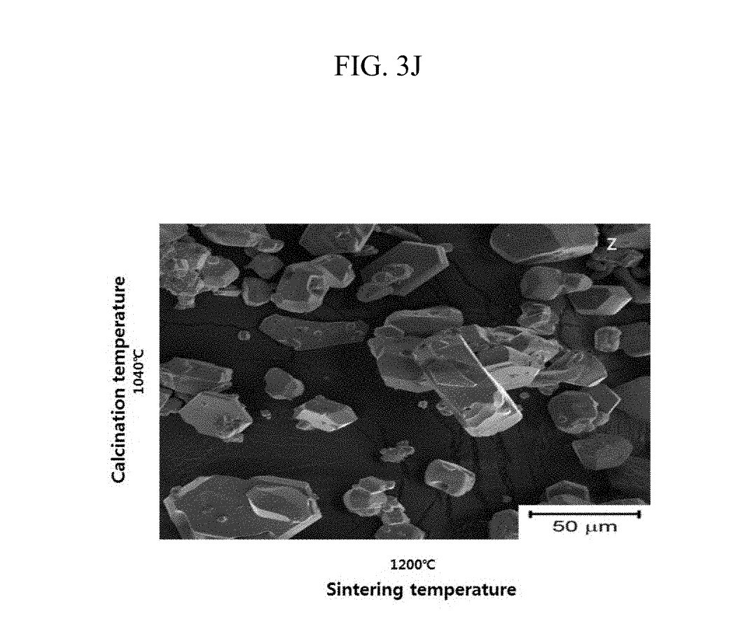

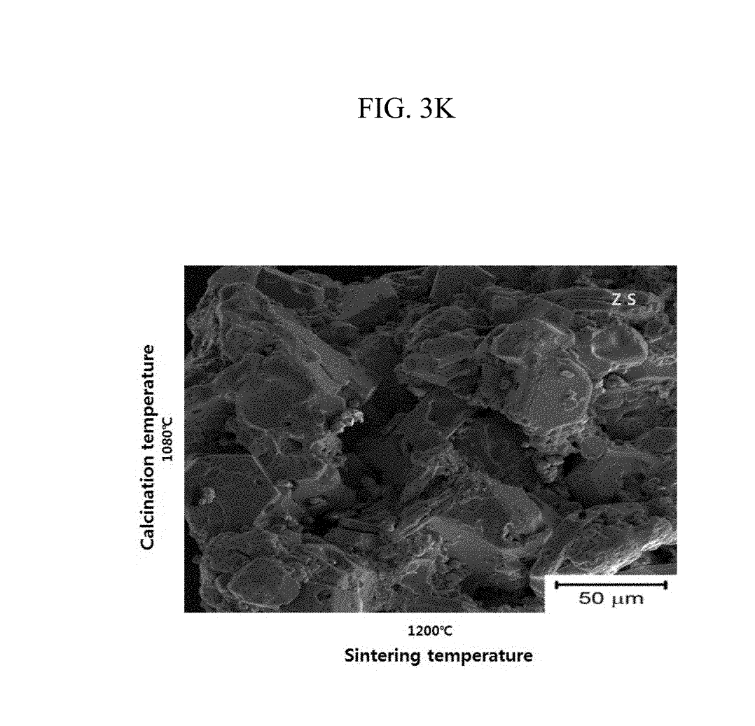

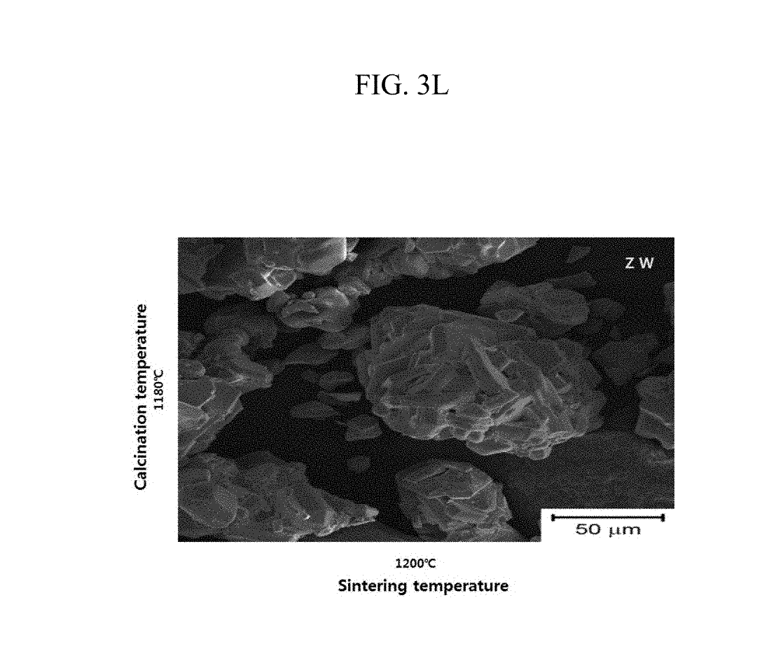

Then the ground precursor is calcinated at a temperature of 1040° C. for 4 hours to provide Intermediate 1. A SEM image of Intermediate 1 is shown in FIG. 3A.

### Manufacture of Intermediate 2

Intermediate 2 is obtained in accordance with the same procedure as in Intermediate 1, except that the calcinating temperature is changed to 1080° C. A SEM image of Intermediate 2 is shown in FIG. 3B.

### Manufacture of Intermediate 3

Intermediate 3 is obtained in accordance with the same procedure as in Intermediate 1, except that the calcinating temperature is changed to 1180° C. A SEM image of Intermediate 3 is shown in FIG. 3C.

### Manufacture of Example 1

The Intermediate 1 and sodium chloride (NaCl) are mixed at a mass ratio of 1:1 and further mixed with a dispersive medium of water or ethanol, ground using a ball mill for 24 hours, and then dried.

The obtained Intermediate 1-NaCl mixture is uniaxially pressed at 10 millipascals (MPa) to provide a pellet-shaped specimen. Then the obtained pellet-shaped specimen is sintered at 1100° C. for 6 hours. After completing the sintering, the pellet is ground using an agate mortar, and then NaCl is removed from the ground pellet by washing with deionized water. Subsequently, the pellet from which NaCl is removed, is dried to provide a magnetic powder according to Example 1 including sheet-shaped particles. A SEM image of Example 1 is shown in FIG. 3D.

### Manufacture of Example 2

Magnetic powder according to Example 2 is obtained in accordance with the same procedure as in Example 1, except that the sintering temperature is changed to 1145° C. A SEM image of Example 2 is shown in FIG. 3G.

### Manufacture of Example 3

Magnetic powder according to Example 3 is obtained in accordance with the same procedure as in Example 1, except that the sintering temperature is changed to 1200° C. A SEM image of Example 3 is shown in FIG. 3J.

### Manufacture of Example 4

Magnetic powder according to Example 4 is obtained in accordance with the same procedure as in Example 1, except that Intermediate 2 is used instead of Intermediate 1. A SEM image of Example 4 is shown in FIG. 3E.

### Manufacture of Example 5

Magnetic powder according to Example 5 is obtained in accordance with the same procedure as in Example 4, except that the sintering temperature is changed to 1145° C. A SEM image of Example 5 is shown in FIG. 3H.

### Manufacture of Example 6

Magnetic powder according to Example 6 is obtained in accordance with the same procedure as in Example 4, except that the sintering temperature is changed to 1200° C. A SEM image of Example 6 is shown in FIG. 3K.

### Manufacture of Example 7

Magnetic powder according to Example 7 is obtained in accordance with the same procedure as in Example 1, except that Intermediate 3 is used instead of Intermediate 1. A SEM image of Example 7 is shown in FIG. 3F

### Manufacture of Example 8

Magnetic powder according to Example 8 is obtained in accordance with the same procedure as in Example 7, except that the sintering temperature is changed to 1145° C. A SEM image of Example 8 is shown in FIG. 3I.

### Manufacture of Example 9

Magnetic powder according to Example 9 is obtained in accordance with the same procedure as in Example 7, except that the sintering temperature is changed to 1200° C. A SEM image of Example 9 is shown in FIG. 3L.

All magnetic powders according to Examples 1 to 9 are hexaferrite having a Z-type phase represented by Ba_{1.5}Sr_{1.5}Co₂Fe₂₄O₄₁.

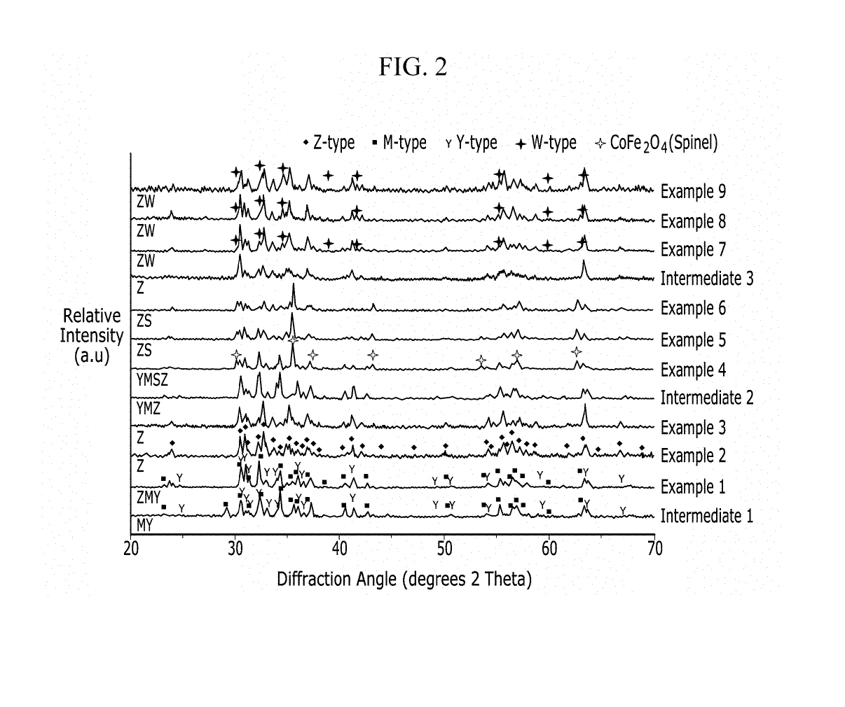

Intermediates 1 to 3 and magnetic powders according to Examples 1 to 9 are measured by X-ray diffraction (XRD) analysis to provide an XRD pattern and the results are shown in FIG. 2. SEM images for each of Intermediates 1 to 3 and Examples 1 to 9 are shown FIGS. 3A-3L.

### Manufacture of Intermediate 4

BaCO₃, SrCO₃, CaCO₃, Co₃O₄, Fe₂O₃, which are starting materials, are weighted to provide a mole ratio of Ba:Sr:Ca:Co:Fe=1.4:1.4:0.2:2:24 and mixed, so as to provide an iron-containing precursor.

Subsequently, the iron-containing precursor and a dispersive medium of water or ethanol are mixed, ground using a ball mill for 24 hours, and then dried.

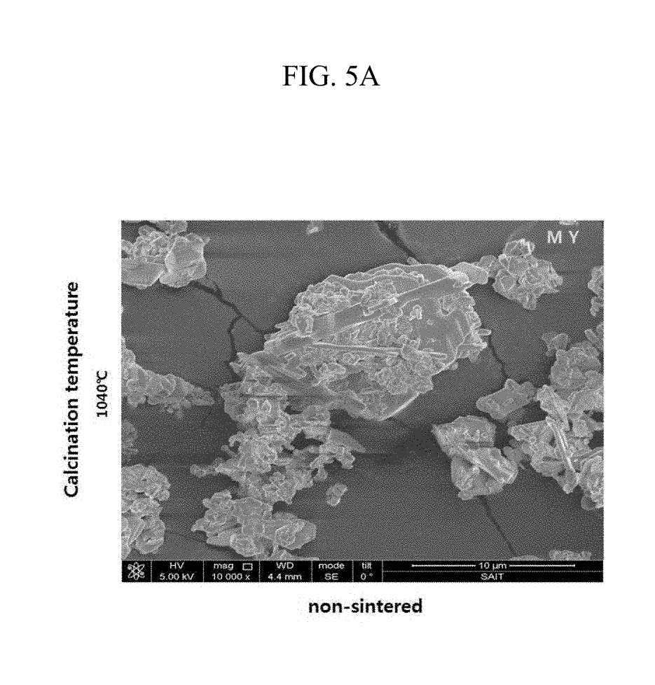

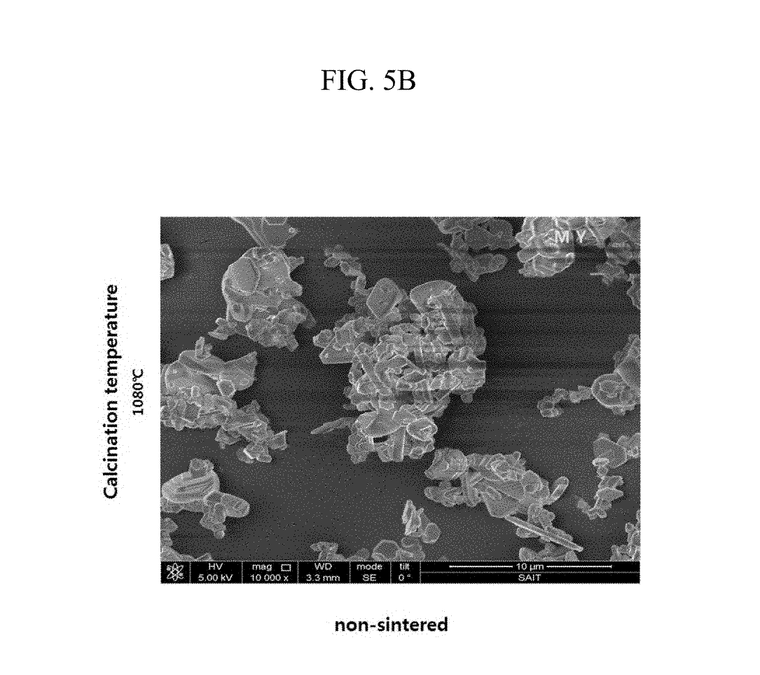

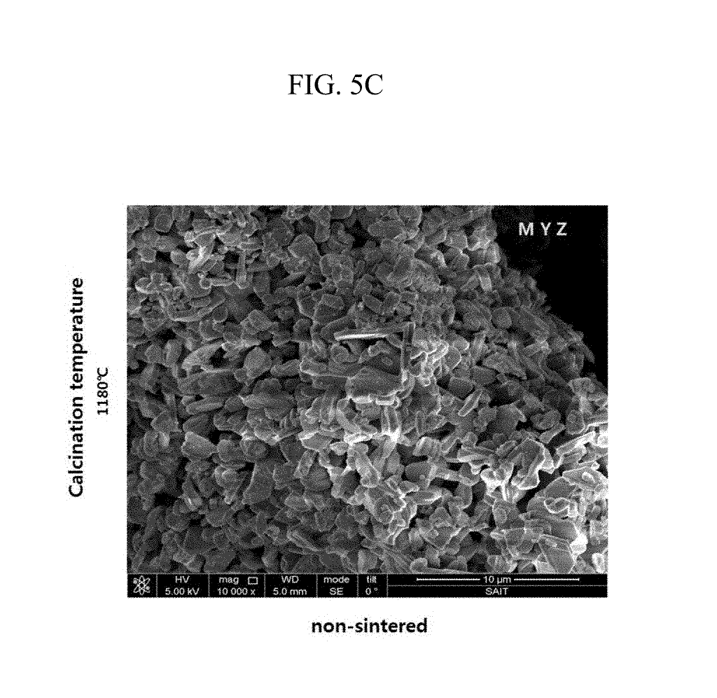

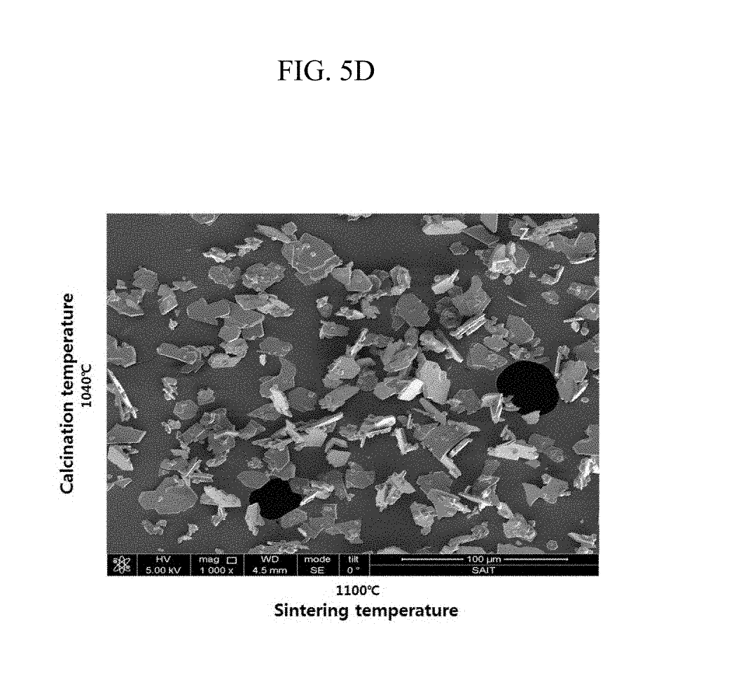

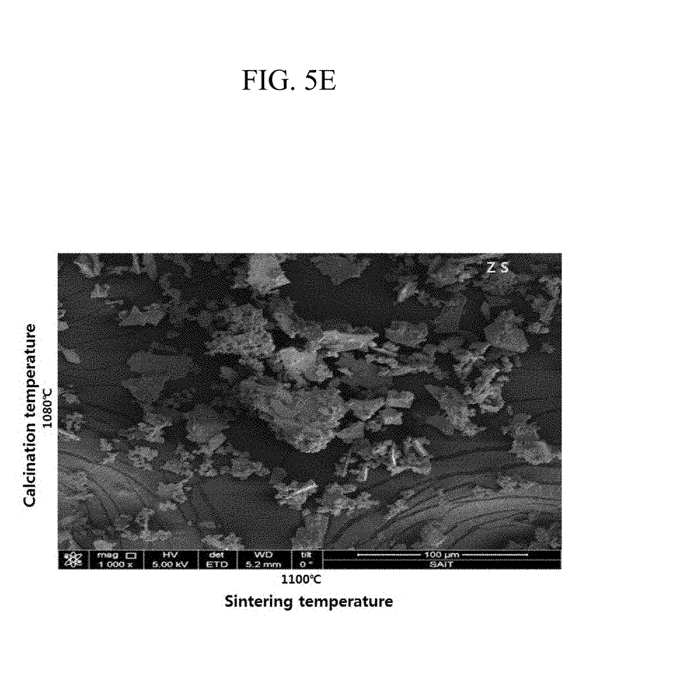

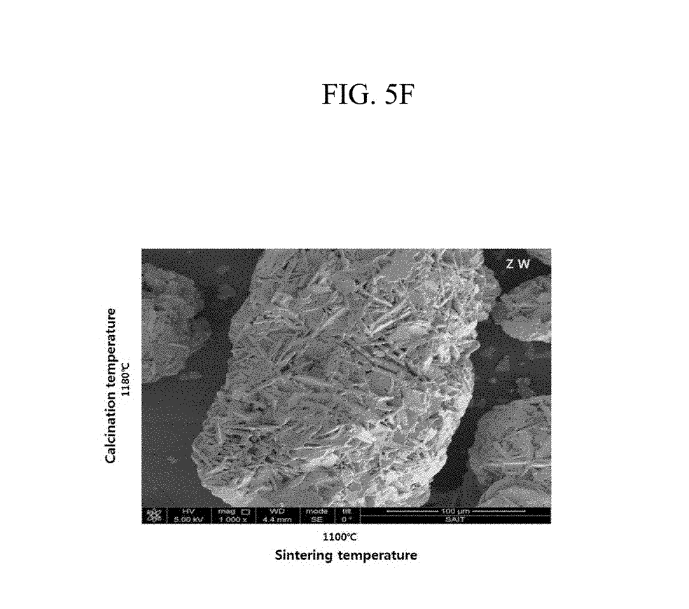

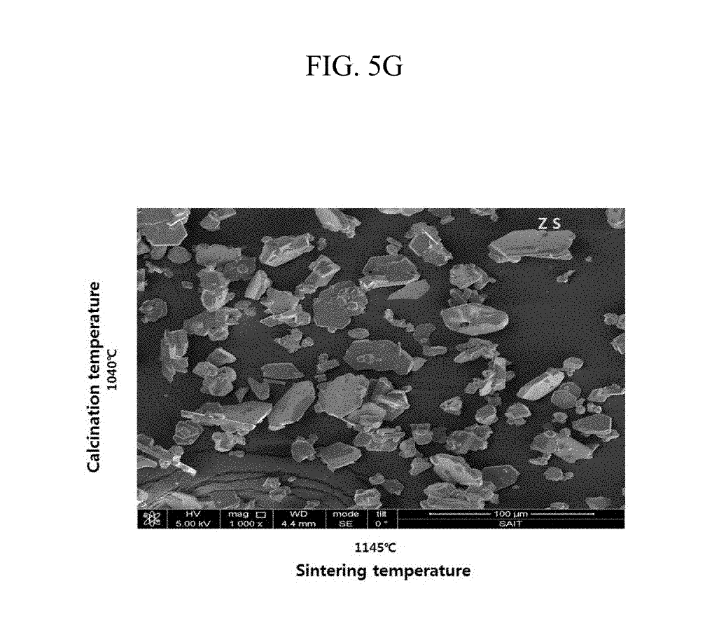

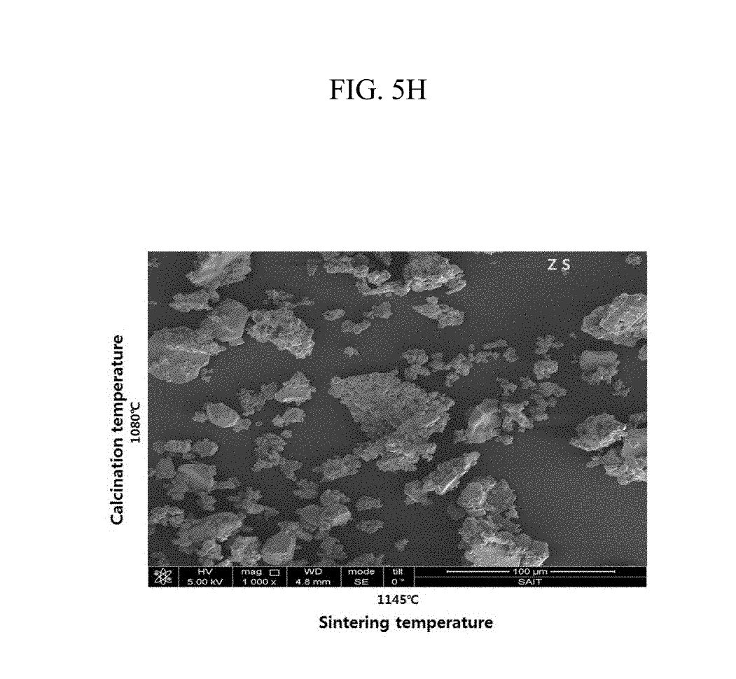

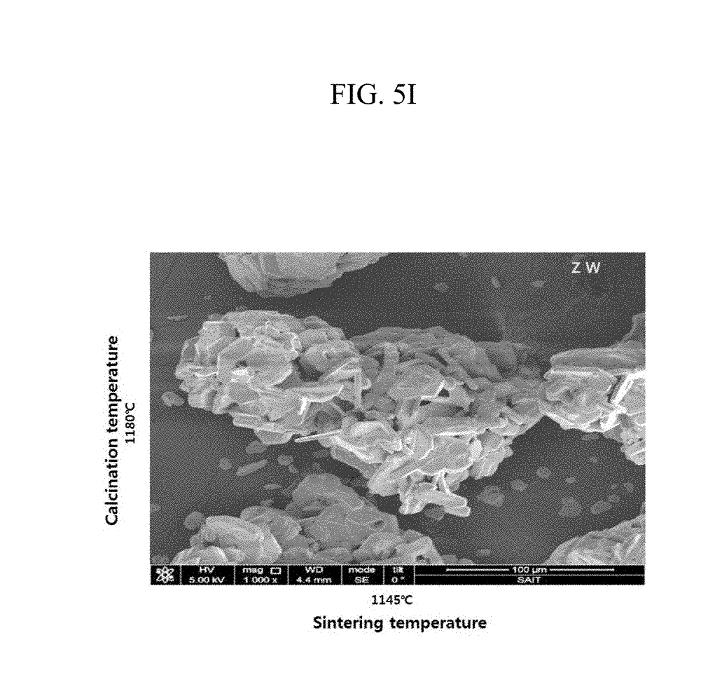

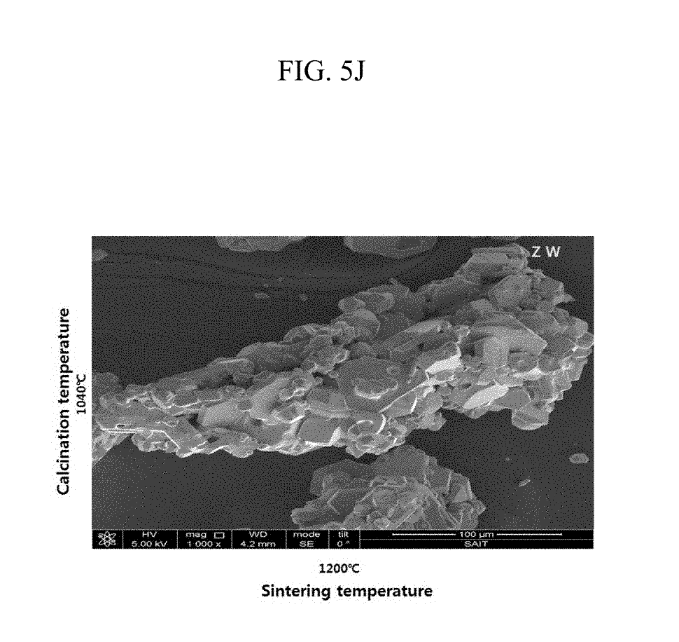

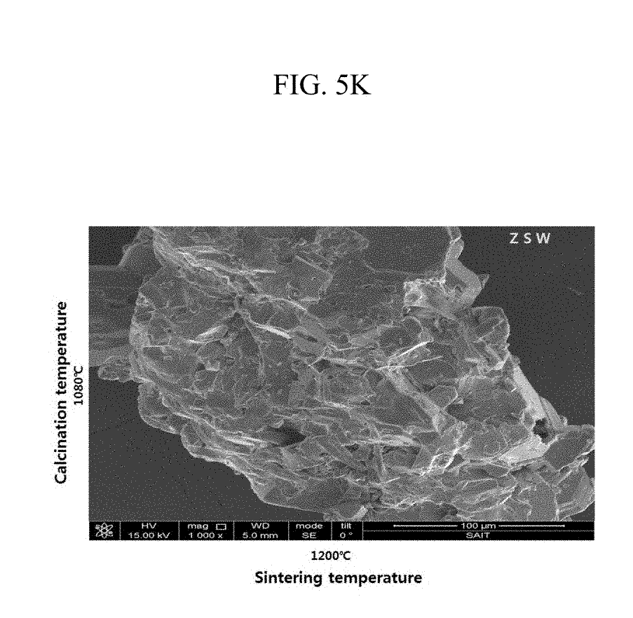

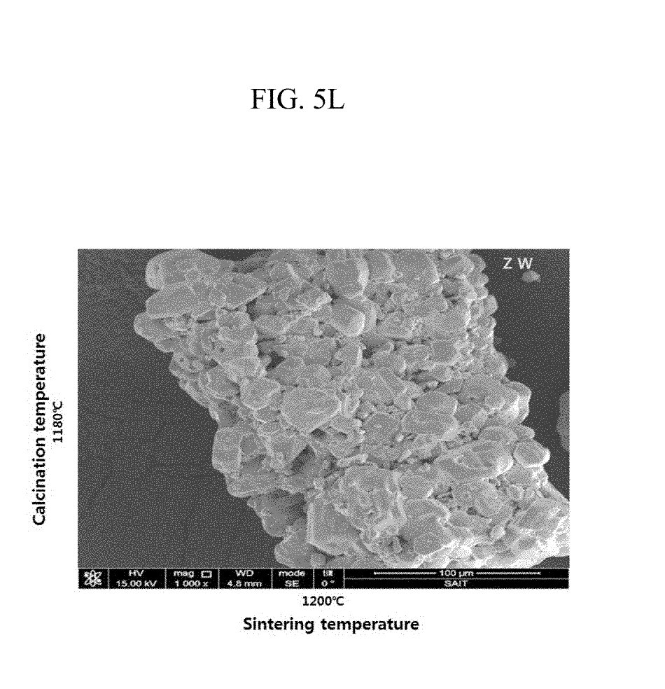

Then the ground precursor is calcinated at a temperature of 1040° C. for 4 hours to provide Intermediate 4. A SEM image of Intermediate 4 is shown in FIG. 5A.

### Manufacture of Intermediate 5

Intermediate 5 is obtained in accordance with the same procedure as in Intermediate 4, except that the calcinating temperature is changed to 1080° C. A SEM image of Intermediate 4 is shown in FIG. 5B.

### Manufacture of Intermediate 6

Intermediate 6 is obtained in accordance with the same procedure as in Intermediate 4, except that the calcinating temperature is changed to 1180° C. A SEM image of Intermediate 4 is shown in FIG. 5C.

### Manufacture of Example 10

The Intermediate 4 and sodium chloride (NaCl) are mixed in a mass ratio of 1:1 and, in addition, further mixed with a dispersive medium of water or ethanol, ground using a ball mill for 24 hours, and then dried.

The obtained intermediate 4-NaCl mixture is uniaxially pressed at 10 MPa to provide a pellet-shaped specimen. Then the obtained pellet-shaped specimen is sintered at 1100° C. for 6 hours. After completing the sintering, the pellet is ground using an agate mortar, and then NaCl is removed from the ground pellet by washing with deionized water. Then the pellet from which NaCl is removed is dried to provide a magnetic powder according to Example 10, including sheet-shaped particles. A SEM image of Example 10 is shown in FIG. 5D.

### Manufacture of Example 11

Magnetic powder according to Example 11 is obtained in accordance with the same procedure as in Example 10, except that the sintering temperature is changed to 1145° C. A SEM image of Example 11 is shown in FIG. 5G.

### Manufacture of Example 12

Magnetic powder according to Example 12 is obtained in accordance with the same procedure as in Example 10, except that the sintering temperature is changed to 1200° C. A SEM image of Example 12 is shown in FIG. 5J.

### Manufacture of Example 13

Magnetic powder according to Example 13 is obtained in accordance with the same procedure as in Example 10, except that Intermediate 5 is used instead of Intermediate 4. A SEM image of Example 13 is shown in FIG. 5E.

### Manufacture of Example 14

Magnetic powder according to Example 14 is obtained in accordance with the same procedure as in Example 13, except that the sintering temperature is changed to 1145° C. A SEM image of Example 14 is shown in FIG. 5H.

### Manufacture of Example 15

Magnetic powder according to Example 15 is obtained in accordance with the same procedure as in Example 13, except that the sintering temperature is changed to 1200° C. A SEM image of Example 15 is shown in FIG. 5K.

### Manufacture of Example 16

Magnetic powder according to Example 16 is obtained in accordance with the same procedure as in Example 10, except that Intermediate 6 is used instead of Intermediate 4. A SEM image of Example 16 is shown in FIG. 5F.

### Manufacture of Example 17

Magnetic powder according to Example 17 is obtained in accordance with the same procedure as in Example 16, except that the sintering temperature is changed to 1145° C. A SEM image of Example 17 is shown in FIG. 5I.

### Manufacture of Example 18

Magnetic powder according to Example 18 is obtained in accordance with the same procedure as in Example 16, except that the sintering temperature is changed to 1200° C. A SEM image of Example 18 is shown in FIG. 5L.

All magnetic powders according to Examples 10 to 18 are hexaferrite having a Z-type phase represented by Ba_{1.4}Sr_{1.4}Ca_{0.2}Co₂Fe₂₄O₄₁.

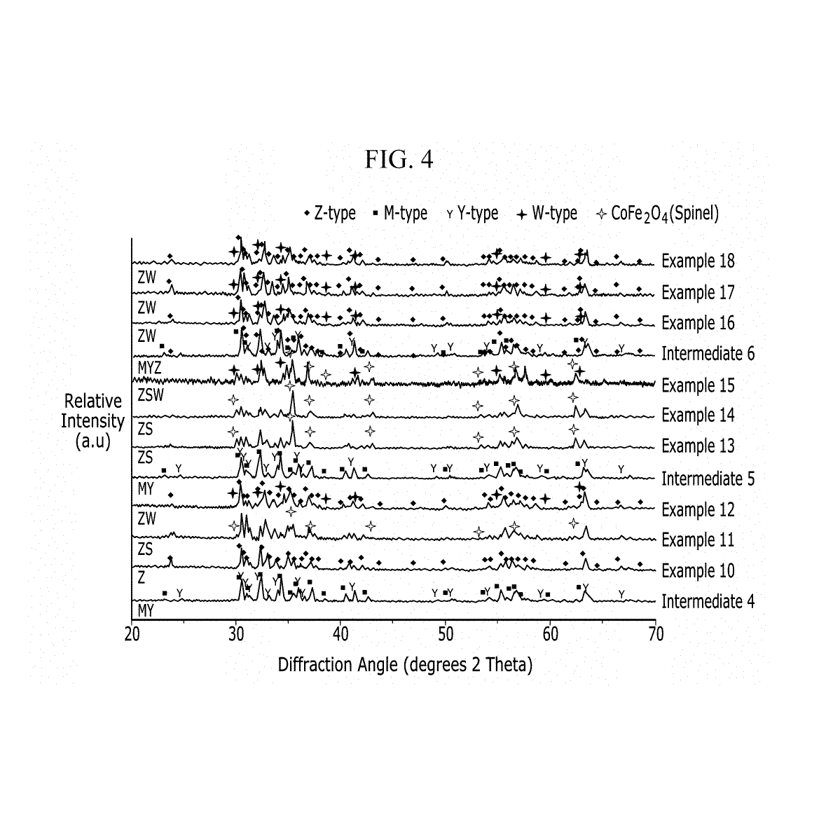

Intermediates 4 to 6 and magnetic powders according to Examples 10 to 18 are measured by XRD analysis to obtain an XRD pattern and the results are shown in FIG. 4. SEM images of Intermediates 4 to 6 and Examples 10 to 18 are shown in FIGS. 5A to 5L.

### Manufacture of Comparative Example

BaCO₃, Co₃O₄, Fe₂O₃, which are starting materials, are weighted to provide a mole ratio of Ba:Co:Fe=3:2:24 and mixed, so as to provide an iron-containing precursor. Subsequently, the iron-containing precursor and a dispersive medium of water or ethanol are mixed, ground using a ball mill for 24 hours, and then dried.

Subsequently, the ground precursor is calcinated at a temperature of 1180° C. for 4 hours to provide a Comparative Intermediate.

Then Comparative Intermediate and sodium chloride (NaCl) are mixed at a mass ratio of 1:1 and, in addition, further mixed with a dispersive medium of water or ethanol, ground using a ball mill for 24 hours, and then dried.

The obtained Comparative Intermediate-NaCl mixture is uniaxially pressed at 10 MPa to provide a pellet-shaped specimen. Then the obtained pellet-shaped specimen is sintered at 1200° C. for 6 hours. After completing the sintering, the pellet is ground using an agate mortar, and then NaCl is removed from the ground pellet using deionized water. Then the pellet from which NaCl is removed is dried to provide a magnetic powder according to Comparative Example, including sheet-shaped particles. The magnetic powder according to Comparative Example is represented by Ba₃Co₂Fe₂₄O₄₁.

### Manufacture of Composites of Examples 1 to 18 and Comparative Example

Each magnetic powder obtained from Examples 1 to 18 is mixed with a polydimethylsilazane (PDMS) resin and agitated to provide a magnetic powder-PDMS composite resin, and then the magnetic powder-PDMS composite resin is cured to provide corresponding Composite 1 to Composite 18.

Comparative Composite 1 is obtained in accordance with the same procedure as in the method of making Composites 1 to 18, except using the magnetic powder obtained from Comparative Example.

Each magnetic powder according to Examples 1 to 18 and Comparative Example is present in an amount of about 50 wt %, based on the total weight of each composite sample.

Composite Sample 19 and Comparative Composite Sample 2 are further prepared by including the magnetic powder obtained from Example 18 and Comparative Example in an amount of 80 wt %, based on the total weight of each composite sample.

### Analysis 1: XRD Patterns and SEM Images of Intermediates 1 to 3 and Examples 1 to 9

FIG. 2 is a graph showing XRD analyses of Examples 1 to 9 and Intermediates 1 to 3, and FIGS. 3A to 3L are SEM images of Examples 1 to 9 and Intermediates 1 to 3, prepared under different calcinating and sintering temperature conditions. In FIGS. 2 and 3A-3L, the CoFe₂O₄ phase is indicated as “S” for convenience.

Referring to FIGS. 2 and 3A-3L, it is confirmed that Intermediate 1 (calcinating temperature: 1040° C.) shows a mixed phase of 2 phases of M-type phase (“M”) and Y-type phase (“Y”). On the other hand, Intermediate 2 (calcinating temperature: 1080° C.) shows a mixed phase of 3 phases of Y-M-Z; and Intermediate 3 (calcination temperature: 1180° C.) shows a Z single phase (“Z”). Since Intermediate 1 does not include a Z-type phase, it is understood that the sheet-shaped particle is not grown yet, while Intermediate 2 has a structure in which two or more sheet-shaped particles are agglomerated, and Intermediate 3 is formed of a plurality of sheet-shaped particles.

Comparing the particle growth of Intermediate 1 according to the sintering temperature, it is confirmed that the phase of Example 1 (sintering temperature: 1100° C.) is changed from an M-Y phase to a mixed phase of 3 phases of Z-M-Y. However, since the relative amount of Z-type phase in Example 1 is very low, as shown in the XRD pattern of FIG. 2, the sheet-shaped particle is rarely found, as shown in FIG. 3D.

However, in the cases of Example 2 (sintering temperature: 1145° C.) and Example 3 (sintering temperature: 1200° C.), the phase is changed from a M-Y phase to a Z single phase, and it is confirmed that a plurality of sheet-shaped particles are found as shown in FIGS. 2, 3E and 3F.

Comparing the particle growth of Intermediate 2 depending upon the sintering temperature, Example 4 (sintering temperature: 1100° C.) is changed from a Y-M-Z phase to a mixed phase of 4 phases of Y-M-S-Z, and the sheet-shaped particle is rarely found as in Example 1.

As Example 5 (sintering temperature: 1145° C.) is changed from the Y-M-Z phase to a mixed phase of 2 phases of Z-S, it is confirmed that a plurality of sheet-shaped particles are formed. However, in the case of Example 6 (sintering temperature: 1145° C.), it has a mixed phase of 2 phases of Z-S as in Example 5, but it is confirmed that the plurality of sheet-shaped particles are agglomerated to form a large agglomeration. Example 6 has a decreased ratio of Z-type phase than Example 5 and an increased ratio of the CoFe₂O₄ phase, so the particles appear to have a shape of the spinel-like structure.

Comparing the particle growth of Intermediate 3 according to the sintering temperature, it is confirmed that the phase of Example 7 (sintering temperature: 1100° C.), Example 8 (sintering temperature: 1145° C.), and Example 9 (sintering temperature: 1200° C.) are all changed from a Z single phase to a mixed phase of 2 phases of Z-W. However, as the sintering temperature increases, the thickness of the sheet-shaped particle becomes thicker and the shape of the agglomeration of the sheet-shaped particles gradually nears a spherical shape.

### Analysis 2: XRD Patterns and SEM Images of Intermediates 4 to 6 and Examples 10 to 18

FIG. 4 is a graph showing XRD analyses of Examples 10 to 18 and Intermediates 4 to 6; and FIGS. 5A to 5L are SEM images of Examples 10 to 18 and Intermediates 4 to 6 prepared under different calcinating and sintering temperature conditions. In FIGS. 4 and 5A to 5L, CoFe₂O₄ is indicated as “S” for convenience.

Referring to FIG. 4 and FIGS. 5A to 5L, it is confirmed that Intermediate 4 (calcinating temperature: 1040° C.) and Intermediate 5 (calcination temperature: 1040° C.) show a mixed phase of the 2 phases M-Y similar to Intermediate 1. On the other hand, Intermediate 6 (calcinating temperature: 1180° C.) shows a mixed phases of the 3 phases M-Y-Z similar to Intermediate 2. Therefrom, it is confirmed that the phases may be different from each other depending upon the composition of the starting material even under the same calcination conditions.

Comparing the particle growth of Intermediate 4 according to the sintering temperature, it is confirmed that the M-Y phase is changed to a Z single phase in Example 10 (sintering temperature: 1100° C.), while Example 11 (sintering temperature: 1145° C.) appears to have a mixed phase of 2 phases of Z-S and Example 12 (sintering temperature: 1200° C.) appears to have a mixed phase of 2 phases of Z-W. All Examples 10 to 12 include a Z phase, however, it is confirmed that the sheet-shaped particle in Example 10 is noticeably formed to have a Z single phase, the sheet-shaped particle is changed to a spinel-like structure in Example 11, and a large amount of the sheet-shaped particles are agglomerated to form an agglomeration in Example 12.

Comparing the particle growth of Intermediate 5 according to the sintering temperature, the M-Y phase is changed to a mixed phase of 2 phases of Z-S in Example 13 (sintering temperature: 1100° C.) and Example 14 (sintering temperature: 1145° C.), and is changed to a mixed phase of 3 phases of Z-S-W in Example 15 (sintering temperature: 1200° C.).

Comparing the particle growth of Intermediate 6 according to the sintering temperature, it is confirmed that the Z single phase is changed to a mixed phase of 2 phases of Z-W for each of Example 16 (sintering temperature: 1100° C.), Example 17 (sintering temperature: 1145° C.), and Example 18 (sintering temperature: 1200° C.), but the sheet-shaped particles thereof are more agglomerated than those in Example 7 to Example 9 as the sintering temperature is increased.

### Analysis 3: Coercive Force (Hc) and Magnetic Saturation (Ms) of Examples 1 to 9

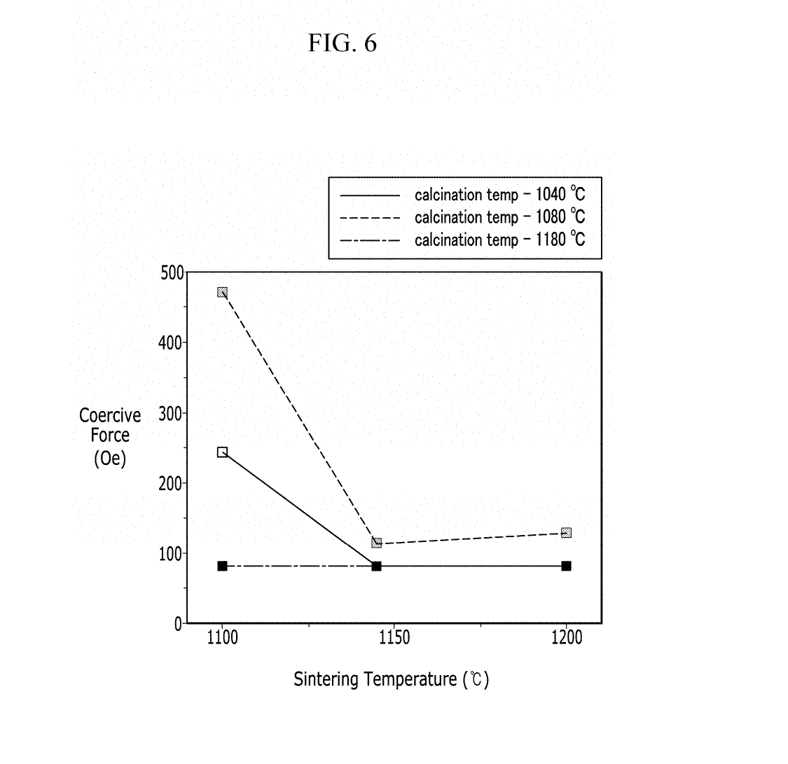

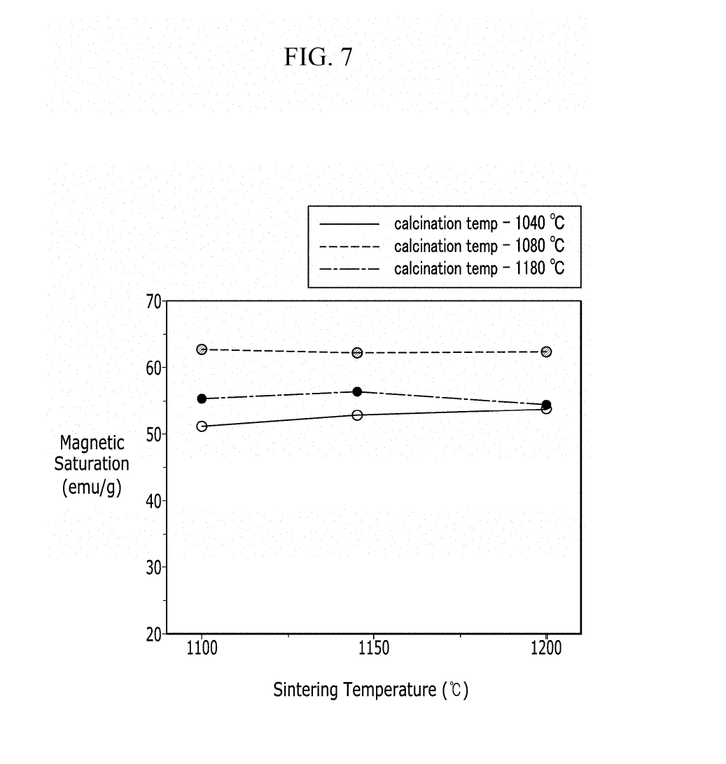

Magnetic powders according to Examples 1 to 9 are measured for to determine the coercive force (Hc) and magnetic saturation (Ms) of each, and the results are shown in FIG. 6 and FIG. 7, respectively.

FIG. 6 is a graph showing a change in coercive force (H) for Examples 1 to 9 depending upon the sintering temperature; and FIG. 7 is a graph showing a change in magnetic saturation (Magnetic, Mₛ) for Examples 1 to 9 depending upon the sintering temperatures

Referring to FIG. 6, the coercive force at a sintering temperature of 1100° C. is shown in the order of Example 4 (calcination temperature: 1080° C.)>Example 1 (calcination temperature: 1040° C.)>Example 7 (calcination temperature: 1180° C.). Since the M-type phase and the CoFe₂O₄ phase are believed to cause the increase in the coercive force of the magnetic powder, Example 4 and Example 1 show a high coercive force. In particular, Example 4 in which the M-type phase and the CoFe₂O₄ phase coexist, shows a high coercive force of 490 Oe.

At the sintering temperature of 1150° C., the order of coercive force is Example 5 (calcination temperature: 1080° C.)>Example 2 (calcination temperature: 1040° C.)=Example 8 (calcination temperature: 1180° C.). Particularly, it is confirmed that the coercive forces of Examples 5 and 2 are significantly decreased compared to those of Examples 4 and 1, which is considered to occur because the M-type phase is changed to another different phase according to the change in the sintering conditions.

At a sintering temperature of 1200° C., the order is Example 6 (calcination temperature: 1080° C.)>Example 3 (calcination temperature: 1040° C.)=Example 9 (calcination temperature: 1180° C.), showing that the coercive force of Example 6 relative to Example 5 is slightly increased. It is believed this occurs because a portion of the Z-type phase of Example 5 is changed to a CoFe₂O₄ phase according to the change in the sintering conditions.

As in above, at a sintering temperature of 1100° C., even in the cases of Examples 4 and 1 showing a relatively high coercive force, it is adjusted to have the coercive force around 100 Oe which is similar to other Examples according to the change in the sintering temperature, so as to provide a magnetic powder having a low coercive force.

Referring to FIG. 7, at a sintering temperature of 1100° C., the magnetic saturation order is Example 4 (calcination temperature: 1080° C.)>Example 7 (calcination temperature: 1180° C.)>Example 1 (calcination temperature: 1040° C.). Particularly, the CoFe₂O₄ phase has a relatively high magnetic saturation comparing to other phases, so it is understood that Example 4 shows a higher magnetic saturation than Examples 7 and 1, including no CoFe₂O₄ phase.

At a sintering temperature of 1150° C., the order is Example 5 (calcination temperature: 1080° C.)>Example 8 (calcination temperature: 1180° C.)>Example 2 (calcination temperature: 1040° C.). Since Example 5 has a CoFe₂O₄ phase, the magnetic saturation thereof is the highest, while Examples 8 and 2 have a magnetic saturation similar to Examples 7 and Example 1, respectively.

At a sintering temperature of 1200° C., the order is Example 6 (calcination temperature: 1080° C.)>Example 3 (calcination temperature: 1040° C.)=Example 9 (calcination temperature: 1180° C.). Since Example 6 includes a CoFe₂O₄ phase, the magnetic saturation thereof is the highest, while the magnetic saturation of Example 9 is slightly decreased to be a similar level to Example 3.

Thus it would appear that, with reference of the Z-type phase having the magnetic saturation near 50 emu/g, when the sintering temperature is relatively low, the fine CoFe₂O₄ phase or M-type phase is formed to slightly increase the magnetic saturation, and when the sintering temperature is relatively high, it is changed to the Z-type single phase, so that the magnetic saturation is relatively decreased comparing to the case of existing the CoFe₂O₄ phase or the M-type phase.

Comparing the spinel ferrite having a magnetic saturation of greater than about 80 emu/g, Examples 4 to 6 shows a magnetic saturation of less than or equal to about 64 emu/g even though they include a CoFe₂O₄ phase having a spinel structure, and the other Examples show a lower magnetic saturation of about 50 emu/g.

Thus, the magnetic powders according to Examples 1 to 9 have both the low coercive force and the low magnetic saturation, so it is confirmed that they have excellent soft magnetism characteristics.

### Analysis 4: Electromagnetic Properties of Example 1 to Example 9

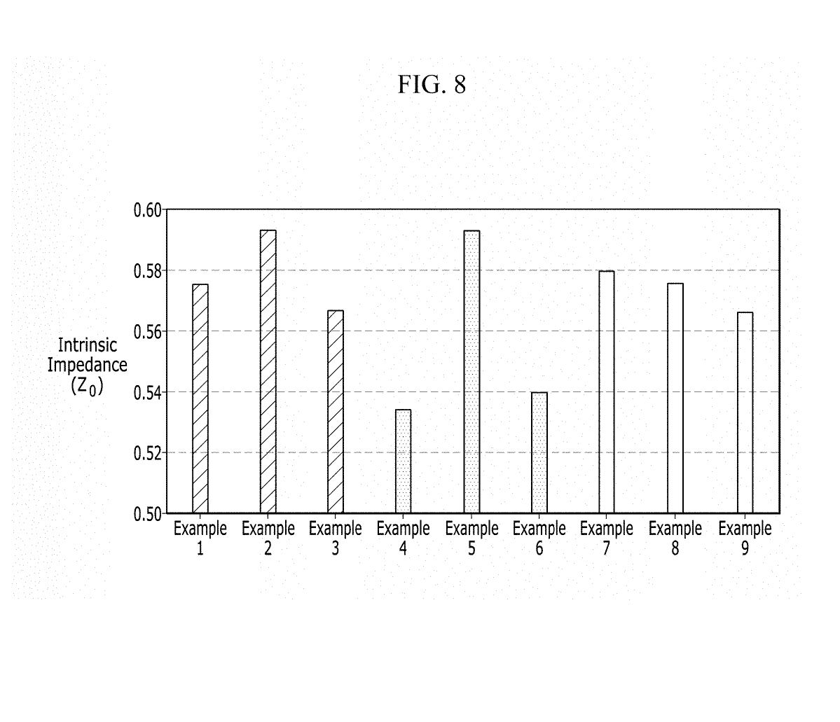

Each of the magnetic powders of Examples 1 to 9 is measured for a dielectric constant and a permeability under the frequency condition of 400 MHz. Then an intrinsic impedance, a dielectric loss tangent (tan δ₁), and a magnetic loss tangent (tan δ₂) under the frequency condition of 400 MHz are calculated based on the same, and the results are shown in FIGS. 8 to 10.

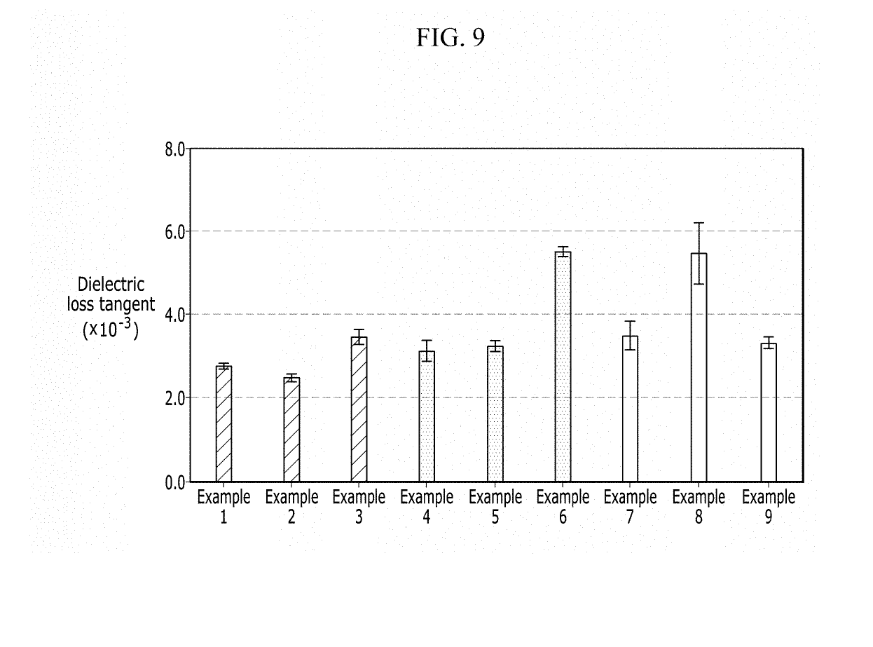

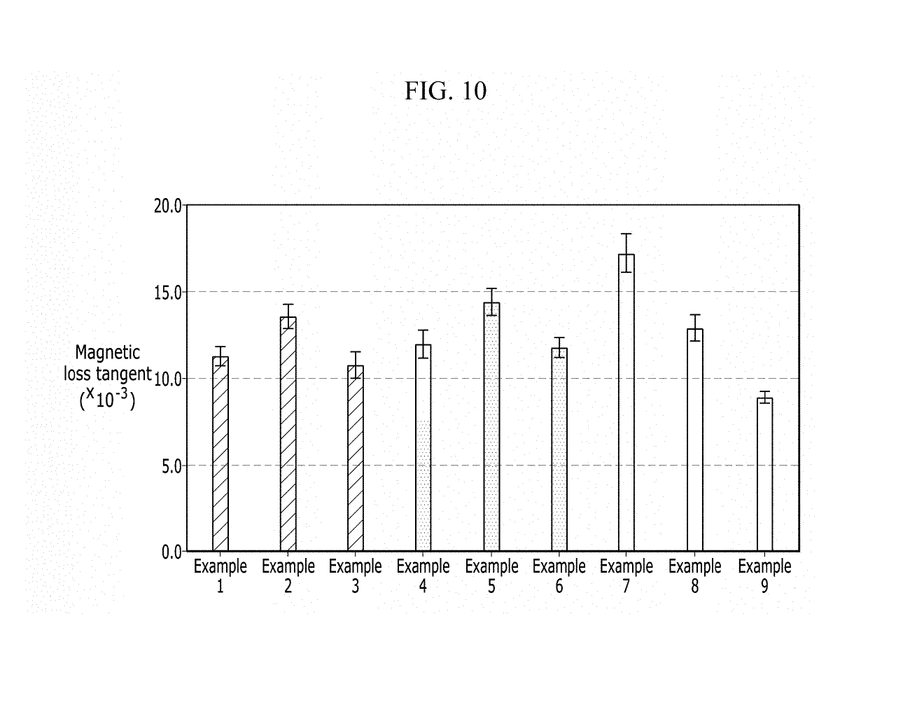

FIG. 8 is a graph showing the intrinsic impedance of Examples 1 to 9, FIG. 9 is a graph showing the dielectric loss tangent of Examples 1 to 9, and FIG. 10 is a graph showing the magnetic loss tangent of Examples 1 to 9.

Referring to FIG. 8, it is understood that all Examples 1 to 9 have an intrinsic impedance of greater than or equal to about 0.53. Since the intrinsic impedance is a square root of a ratio of a permeability relative to a dielectric constant, when it is calculated to a permeability relative to a dielectric constant, the value will be greater than or equal to about 0.28.

Meanwhile, Examples 2 and 5 show the highest intrinsic impedance, and Examples 1, and 7 to 9 also show a high level, thus it is understood that the intrinsic impedance is depended upon a ratio of Z-type phase in the magnetic powder.

Referring to FIGS. 9 and 10, it is confirmed that each of Examples 1 to 9 have a dielectric loss tangent of less than or equal to about 0.006 and a magnetic loss tangent of less than or equal to about 0.018. That is, it is confirmed that dielectric loss tangents and the magnetic loss tangents of the magnetic powders are very low at a low frequency band.

### Analysis 5: Changes of Magnetic Loss Tangent of Example 9, Example 18, and Comparative Example Depending on Frequency Band

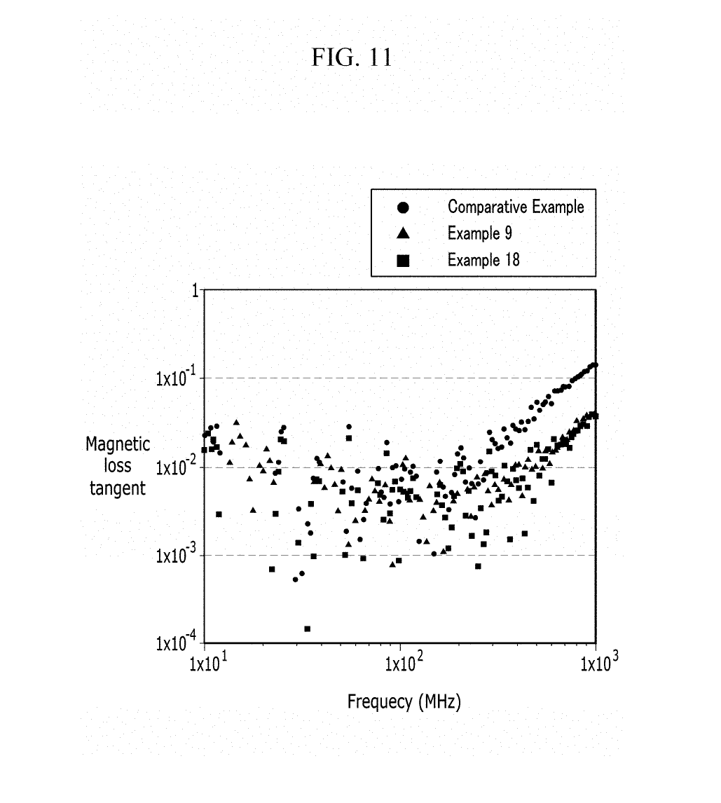

FIG. 11 is a graph showing changes in the magnetic loss tangent of Example 9, Example 18, and Comparative Example depending on frequency bands. In FIG. 11, the x-axis and the y-axis are represented by a log scale.

Referring to FIG. 11, Example 9, Example 18, and the Comparative Example all have the similar magnetic loss tangents at a frequency band of about 100 MHz, however, the magnetic loss tangent of the Comparative Example tends to gradually increase to a level which is higher than those of Example 9 and Example 18 at a frequency band from greater than or equal to about 200 MHz to about 1 GHz.

Thus the magnetic powder according to an embodiment has lower magnetic loss tangent than that of Comparative Example at a low frequency band, and the magnetic characteristics thereof is also excellent even at a high frequency bend of around 1 GHz.

### Analysis 6: Electromagnetic Properties of Composites 1 to 18 and Comparative Composite 1

Under the condition of a frequency of 400 MHz, Composite 1 to Composite 18 and Comparative Composite 1 are each measured for the dielectric constant and the permeability, and the dielectric loss tangents and the magnetic loss tangents are calculated based on the results. Subsequently, among composite samples, electromagnetic properties of Composite 2, Composite 5, Composite 8, Composite 9, Composite 18, and Comparative Composite 1 are each shown in the following Table 1:

TABLE 1

| | Calcination | Sintering | Dielectric | Dielectric | | Magnetic |
|---|---|---|---|---|---|---|
| | temperature | temperature | constant | loss | Permeability | loss |
| | (° C.) | (° C.) | (F/m) | tangent | (H/m) | tangent |
| Composite 2 | 1040 | 1145 | 4.62 | 0.0025 | 1.63 | 0.0136 |
| Composite 5 | 1080 | 1145 | 4.59 | 0.0032 | 1.62 | 0.0144 |
| Composite 8 | 1180 | 1145 | 4.60 | 0.0055 | 1.53 | 0.0129 |
| Composite 9 | 1180 | 1200 | 4.43 | 0.0033 | 1.42 | 0.0089 |
| Composite 18 | 1180 | 1200 | 4.32 | 0.0041 | 1.48 | 0.0075 |
| Comparative | 1200 | 1200 | 4.37 | 0.0038 | 1.68 | 0.0270 |
| composite 1 | | | | | | |

Referring to Table 1, it is understood that each of Composite 2, Composite 5, Composite 8, Composite 9, and Composite 18 have a very low magnetic loss tangent as compared to Comparative Composite 1. Particularly, Composite 2 shows a higher dielectric constant than Comparative Composite 1 and a similar permeability, but it is confirmed that the dielectric loss tangent thereof is decreased by about 34%, and the magnetic loss tangent thereof is decreased by about 50%, relative to the Comparative Composite 1.

On the other hand, in Composite 9 and Composite 18 which are obtained under the same calcinating-sintering temperature conditions as in Comparative Composite 1, it is confirmed that the magnetic loss tangents thereof are decreased by about 67% and by about 72%, respectively, relative to Comparative Composite 1.

Thereby, it is understood that the composites according to an embodiment have low values in both the dielectric loss tangent and the magnetic loss tangent, particularly, the magnetic loss tangent is lower than that of Comparative Composite.

### Analysis 7: Electromagnetic Properties of Composite 19 to Comparative Composite 2

Under the condition of frequency 400 MHz, Composite 19 and Comparative Composite 2 are each measured for a dielectric constant and a permeability, and the dielectric loss tangent and the magnetic loss tangent are calculated based on the same. Thereafter, the measured and the obtained values are shown in the following Table 2:

TABLE 2

| | Calcination | Sintering | Dielectric | Dielectric | | Magnetic |
|---|---|---|---|---|---|---|
| | temperature | temperature | constant | loss | Permeability | loss |
| | (° C.) | (° C.) | (F/m) | tangent | (H/m) | tangent |
| Composite 19 | 1180 | 1200 | 8.30 | 0.008 | 2.35 | 0.0273 |
| Comparative | 1180 | 1200 | 7.15 | 0.004 | 3.22 | 0.0523 |
| composite 2 | | | | | | |

Referring to Table 2, it is confirmed that, in the cases of Composite 19 and Comparative Composite 2 obtained under the same calcinating-sintering temperature conditions, Composite 19 and Comparative Composite 2 have a similar dielectric loss tangent; but Composite 19 shows a magnetic loss tangent which is decreased by about 47% relative to Comparative Composite 2. Thereby, the same conclusion as in Analysis 6 may be made.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A magnetic composite comprising:
a polymeric substrate; and
a magnetic material comprising a Z-type phase and represented by the following Chemical Formula,
Ba_{1.5-x}Sr_{1.5-x}Ca₂ₓM₂Fe₂₄O₄₁ Chemical Formula
wherein, in the Chemical Formula, M is at least one selected from Co, Ni, Cu, Mg, Mn, Ti, Al, Zn, and Zr, and 0≦x<0.3.

2. The magnetic composite of claim 1, wherein the magnetic material consists of a Z-type single phase.

3. The magnetic composite of claim 1, wherein the magnetic material comprises a sheet-shaped particle, and
wherein a ratio of a length of a major axis of the sheet-shaped particle to a thickness of the sheet-shaped particle is greater than or equal to about 4.

4. The magnetic composite of claim 3, wherein the length of the major axis of the sheet-shaped particle is greater than 0 micrometer and less than or equal to about 50 micrometers.

5. The magnetic composite of claim 1, wherein the magnetic material has a dielectric loss tangent of less than or equal to about 0.006 at a frequency band of about 400 megahertz to about 800 megahertz.

6. The magnetic composite of claim 1, wherein the magnetic material has a magnetic loss tangent of less than or equal to about 0.05 at a frequency band of about 400 megahertz to about 800 megahertz.

7. The magnetic composite of claim 1, wherein the magnetic material has a ratio of a permeability to a dielectric constant of greater than or equal to about 0.28 at a frequency band of about 400 megahertz to about 800 megahertz.

8. The magnetic composite of claim 1, wherein a magnetic saturation of the magnetic material is less than or equal to about 64 electromagnetic units per gram.

9. The magnetic composite of claim 1, wherein the magnetic material is dispersed in the polymer substrate.

10. The magnetic composite of claim 1, wherein the magnetic material is present in an amount of greater than or equal to about 50 weight percent, based on a total weight of the magnetic composite.

11. A method of making the magnetic composite of claim 1, the method comprising:
calcining an iron containing precursor at a temperature of about 1000° C. to about 1200° C. to obtain a calcinated precursor;
mixing the calcinated precursor with a metal salt to obtain a precursor-metal salt mixture;
sintering the precursor-metal salt mixture at a temperature of about 1100° C. to about 1300° C.;
removing the metal salt from the sintered precursor-metal salt mixture to obtain the magnetic material; and
contacting the magnetic material with a polymer resin to obtain the magnetic composite.

12. The method of claim 11, wherein the metal salt comprises at least one metal selected from Na, K, Ca, Mg, Sr, Ba, Al, Sc, Ti, V, Cr, Cu, Zn, Zr, Nb, Mo, and Ag.

13. The method of claim 11, wherein the metal salt includes at least one salt selected from a chloride, a hydroxide, a nitrate, an acetate, a propionate, an acetylacetonate, a methoxide, an ethoxide, a phosphate, a C1 to C10 alkylphosphate, a perchloride, a sulfate, a C1 to C10 alkylsulfonate, and a C1 to C10 alkyl bromide.

14. The method of claim 11, wherein a mass ratio of the precursor to the metal salt in the precursor-metal salt mixture is about 2:1 to about 1:2.

15. The method of claim 11, wherein the method comprises mixing the magnetic material and the polymer resin to obtain a magnetic material-polymer composite resin.

16. The method of claim 15, wherein the method further comprises curing the magnetic material-polymer composite resin.

17. An antenna comprising the magnetic composite of claim 1.
